(19) United States
(12) Patent Application Publication
(10) Pub. No.: US 2025/0061317 A1
(43) Pub. Date: Feb. 20, 2025

(54) METHODS AND APPARATUS FOR ENABLING EFFICIENT FINE-TUNING ON UNSTRUCTURED SPARSE AND LOW-PRECISION LARGE PRE-TRAINED FOUNDATION MODELS

(71) Applicant: INTEL CORPORATION, Santa Clara, CA (US)

(72) Inventors: Juan Pablo Munoz Chiabrando, Folsom, CA (US); Jinjie Yuan, Beijing (CN); Nilesh Kumar Jain, Portland, OR (US)

(73) Assignee: INTEL CORPORATION, Santa Clara, CA (US)

(21) Appl. No.: 18/935,223

(22) Filed: Nov. 1, 2024

(51) Int. Cl. G06N 3/0495

(52) U.S. Cl. CPC G06N 3/0495

(57) ABSTRACT

An example apparatus includes interface circuitry, machine-readable instructions, and at least one processor circuit to be programmed by the machine-readable instructions to sparsify a base model of a foundation model to generate a sparse base model, apply a neural low-rank adapter search to the sparse base model, and output a fine-tuned base model based on application of the neural low-rank adapter search to the sparse base model.

### BACKGROUND

Foundation models (e.g., pre-trained Large Language Models (LLMs)) are neural networks which perform artificial intelligence (AI)-based related tasks. These models utilize millions or billions of parameters that can require fine-tuning for a new dataset or downstream task, such as mathematical reasoning. LLMs include encoder only models for classification tasks, decoder only models for content generation tasks, and encoder-decoder models for content assessment and generation tasks, such as translation and summarization.

### BRIEF DESCRIPTION OF THE DRAWINGS

FIG. 1 illustrates existing limitations of known approaches for fine-tuning sparse and quantized models and merging low-rank (LoRA) adapters.

FIG. 2 is a block diagram of an example implementation of model tuner circuitry constructed in accordance with teachings of this disclosure to fine-tune pre-trained LLMs on downstream tasks.

FIG. 3 is a flowchart representative of example machine-readable instructions and/or example operations that may be executed, instantiated, and/or performed by example programmable circuitry to implement the example model tuner circuitry of FIG. 2.

FIG. 4 is a flowchart representative of example machine-readable instructions and/or example operations that may be executed, instantiated, and/or performed by example programmable circuitry to implement the example model tuner circuitry of FIG. 2 to perform base model sparsification and quantization.

FIG. 5 is a flowchart representative of example machine-readable instructions and/or example operations that may be executed, instantiated, and/or performed by example programmable circuitry to implement the example model tuner circuitry of FIG. 2 to recover model accuracy using neural low-rank adapter search (NLS).

FIG. 6 illustrates example pipeline configurations that can be instantiated to efficiently fine-tune large models, including (1) a first pipeline for parameter-efficient fine-tuning of sparse and quantized models using elastic adapters, resulting in an unmerged model and adapters, (2) a second pipeline for parameter-efficient fine-tuning of sparse models using sparse awareness (SparsePEFT), permitting subsequent merging of the model and adapters, and (3) a third pipeline for parameter-efficient fine-tuning of sparse and quantized models with quantization and sparse-aware adapter merging.

FIG. 7 illustrates an example of known low-rank adapters (LoRA) compared to elastic adapters associated with a neural low-rank search (NLS) disclosed herein.

FIG. 8 illustrates an example overview of fine-tuning pre-trained LLMs based on model sparsification, recovery of base model accuracy using the NLS adapters of FIG. 7, and identification of a sparsified fine-tuned architecture based on a sub-adapter search.

FIG. 9 illustrates sparse parameter-efficient fine-tuning (SparsePEFT) using a binary mask obtained from sparsified weights.

FIG. 10 illustrates an example reduction of parameters needed to fine-tune a LLM while obtaining higher accuracy using methods disclosed herein, as compared to known sparse fine-tuning methods.

FIG. 11A illustrates results for evaluating fine-tuning of an example first model using known fine-tuning as compared to approaches disclosed herein (e.g., fine-tuning of sparce and quantized models (SQFT), SQFT in combination with SparsePEFT, and SQFT in combination with SparsePEFT including quantization and sparse-aware adapter merging (QA-SparsePEFT)).

FIG. 11B illustrates ablation study results for fine-tuning using known low-rank adapters (LoRA) compared to elastic adapters associated with the neural low-rank search (NLS) of FIG. 7 when evaluating fine-tuning disclosed herein, including SQFT with SparsePEFT and SQFT with quantization-aware SparsePEFT.

FIG. 12 illustrates example cost analysis for different pipelines associated with model fine-tuning, including an assessment of model storage, fine-tuning time, and accuracy.

FIG. 13 is a block diagram of an example processing platform including programmable circuitry structured to execute, instantiate, and/or perform the example machine readable instructions and/or perform the example operations of FIGS. 3-5 to implement the model tuner circuitry of FIG. 2.

FIG. 14 is a block diagram of an example implementation of the processor circuitry of FIG. 13.

FIG. 15 is a block diagram of another example implementation of the programmable circuitry of FIG. 13.

FIG. 16 is a block diagram of an example software/firmware/instructions distribution platform (e.g., one or more servers) to distribute software, instructions, and/or firmware (e.g., corresponding to the example machine readable instructions of FIGS. 3-5) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

In general, the same reference numbers will be used throughout the drawing(s) and accompanying written description to refer to the same or like parts. The figures are not necessarily to scale.

### DETAILED DESCRIPTION

Large Language Models (LLMs) include large transformer-based models that exhibit capabilities in a variety of tasks, from language understanding to text generation. State-of-the-art LLMs include billions of parameters used to understand natural language. For example, LLMs are pre-trained with billions or trillions of tokens to improve model robustness in zero-shot evaluations used for measuring model performance. However, LLMs need to be adapted to improve model performance using new tasks and/or datasets. Fine-tuning of the models is needed to increase accuracy, but such efforts require a resource-intensive approach. For example, known approaches to inducing sparsity and fine-tuning in large foundation models include a post-training pruning method for compressing LLMs (e.g., SparseGPT) and fine-tuning of sparse models. These known methods require significant computational resources and a runtime that can take advantage of the resulting sparse weight matrices.

Additionally, parameter-efficient fine-tuning (PEFT) techniques have been developed to reduce the number of parameters used to fine-tune a model. For example, low-rank (LoRA) adapters are a popular PEFT-based technique for modifying a selection of linear layers given a pre-trained model. The LoRA technique modifies a selection of linear layers, each having a weight matrix. Additionally, the LoRA technique uses low-rank adapters to extend a layer's linear projection, allowing the original model weights to remain frozen while fine-tuning only the attached adapters. While the LoRA-based technique has demonstrated effectiveness in model adaptation, the combination of LoRA with model compression techniques (e.g., sparsity, quantization, etc.) introduces challenges associated with the merging of adapters into a single compressed and fine-tuned model. For example, merging dense adapters with sparse model weights results in the loss of sparsity in the updated base model. Likewise, adapter merging is prevented when using model weights in a different numerical precision as compared to the numerical precision of the adapters.

Methods and apparatus disclosed herein enable the efficient fine-tuning of sparse and quantized large pre-trained foundation models. In examples disclosed herein, fine-tuning of LLMs is improved while maintaining a low count of trainable parameters and resource requirements and mitigating the challenge of memory bandwidth. In examples disclosed herein, the resulting fine-tuned models accelerate inference by leveraging existing runtimes that support unstructured sparsity. As such, methods and apparatus disclosed herein introduce efficient fine-tuning that outperforms traditional PEFT approaches. In examples disclosed herein, LLM-based fine-tuning is performed using (1) model sparsification and/or quantization, (2) recovery of accuracy using neural low-rank adapter search (NLS), and (3) identification of a high performing sparsified fine-tuned architecture. For example, NLS is performed on elastic adapters attached to base LLMs. In examples disclosed herein, performance is improved while using an order of magnitude fewer parameters compared to known sparse fine-tuning methods. Methods and apparatus disclosed herein can further be generalized to other transformer-based architectures (e.g., not limited to LLMs) and/or other non-transformer-based architectures (e.g., selective state space models (SSMs)) that use parametrized linear transformations.

Additionally, methods and apparatus disclosed herein merge sparse weights and dense adapters while avoiding loss of sparsity when merging sparse and/or dense matrices. As such, machine learning-based inference can be accelerated by using fewer parameters than other known sparse fine-tuning commercial methods. For example, methods and apparatus disclosed herein outperform Low Rank (LoRA) adapters in dense and sparse configurations. In examples disclosed herein, computational challenges associated with memory bandwidth are addressed by applying a weight compression for sparse fine-tuning. The resulting sparsity in LLMs can be used to improve execution times. For example, model sparsity can be exploited with little (e.g., minimal) compression loss, resulting in significant acceleration, demonstrating that the resulting sparse model can alleviate existing memory bandwidth challenges. Compared to known state-of-the-art techniques for LLM fine-tuning, methods and apparatus disclosed herein use fewer parameters to fine-tune pre-trained LLMs on downstream tasks, require less time to sparsify a given LLM, require less memory use during fine-tuning, and can be utilized in a broader range of hardware.

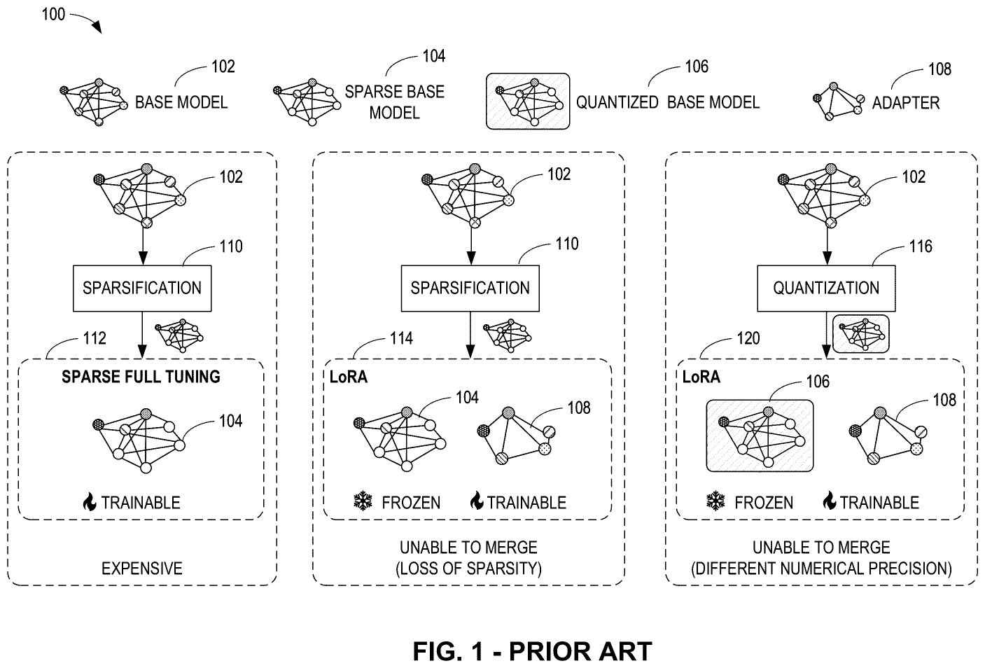

FIG. 1 illustrates existing limitations of known approaches 100 for fine-tuning sparse and quantized models and merging low-rank (LoRA) adapters. Large pre-trained foundation or frontier models are integral to artificial intelligence applications (e.g., language understanding, code generation, etc.). These models are trained using thousands of hardware accelerators (e.g., graphics processing units (GPUs)), resulting in outstanding zero-shot performance across various tasks and datasets (e.g., performance associated with the completion of a task without having received any training examples). However, such models frequently require further adaptation to improve their performance on new tasks and/or data. While low-rank adapters (LoRA) can be used for model adaptation, the combination of such adapters with model compression techniques (e.g., sparsity, quantization, etc.) prevents the merging of these adapters into a single compressed fine-tuned model. For example, merging dense adapters causes loss of sparsity in the base model and/or adapter merging cannot be achieved due to different numerical precisions. As shown in the example of FIG. 1, full fine-tuning is computationally expensive, while LoRA for parameter-efficient fine-tuning (PEFT) on sparse or quantized models cannot easily merge with the compressed weights due to loss of previously induced sparsity and/or different numerical precision. For example, FIG. 1 includes a base model 102, a sparse base model 104, a quantized base model 106, and LoRA-based adapter(s) 108. The sparse base model 104 can be obtained from the initial base model 102 using sparsification 110. While this version of an example sparse full tuning 112 allows for the generation of a trainable sparse model, such a model is expensive in terms of computational resources.

Sparsification encompasses a range of techniques used to compress and optimize neural networks. By removing and/or reducing the significance of less important connections and information within a given model, sparsification often results in a drop in accuracy while yielding a smaller model size, faster inference, and/or reduced energy consumption. For example, in comparison to the sparse full tuning 112, the use of LoRA for PEFT on sparse models 114 results in a lack of merging between the sparse base model 104 and the LoRA-based adapter(s) 108 due to loss of sparsity, while the use of LoRA for PEFT on quantized models 120 results in a lack of merging between the quantized base model 106 and the adapter(s) 108 due to different numerical precisions. In examples disclosed herein, quantization reduces the precision of weights and activations in a neural network (e.g., from 32-bit floating-point numbers to 8-bit integers). For example, quantization decreases model size and/or memory usage, leading to faster inference.

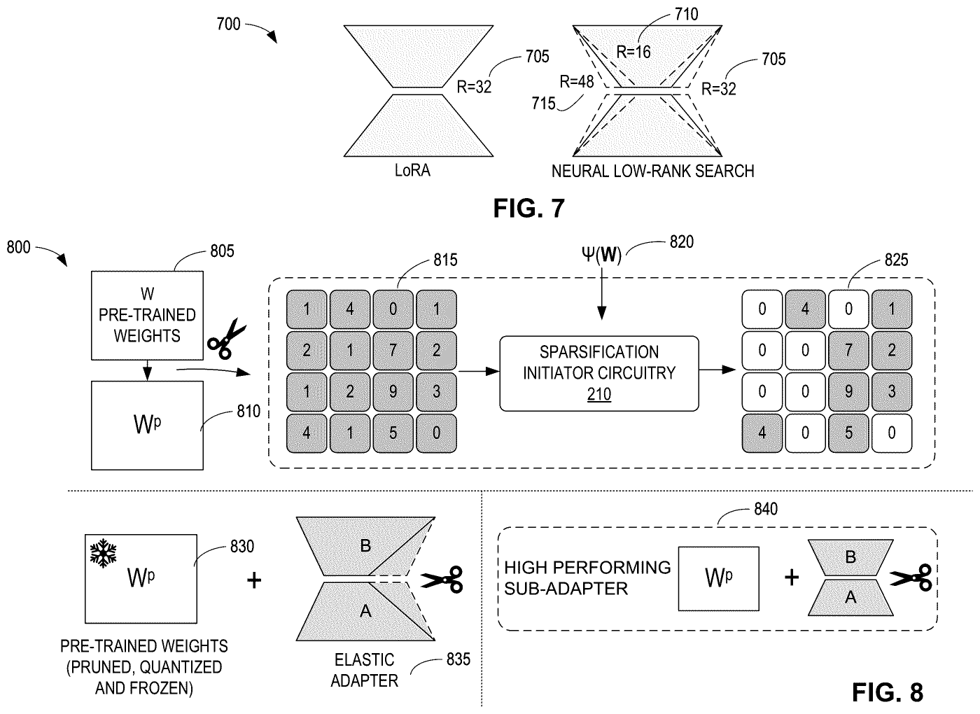

In examples disclosed herein, the adapter(s) 108 are used to reduce the number of parameters to fine tune a model. For example, given a pre-trained model, the adapter(s) 108 can be used to modify a selection of linear layers, each having a weight matrix, as described in more detail in connection with FIG. 7. Low rank adapters can be used to maintain the original model's weights frozen, while only the inserted adapters are fine-tuned, as shown in connection with the use of LoRA for PEFT on sparse models 114 and the use of LoRA for PEFT on quantized models 120, in the example of FIG. 1.

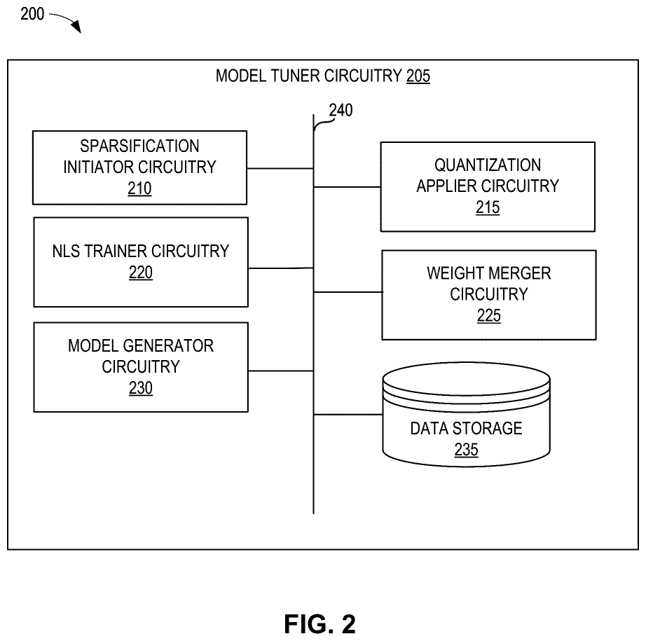

FIG. 2 is a block diagram 200 illustrating an example implementation of model tuner circuitry 205 constructed in accordance with teachings of this disclosure to fine-tune pre-trained LLMs on downstream tasks. The model tuner circuitry 205 of FIG. 2 may be instantiated (e.g., creating an instance of, bring into being for any length of time, materialize, implement, etc.) by programmable circuitry such as a Central Processing Unit (CPU) executing first instructions. Additionally or alternatively, the model tuner circuitry 205 of FIG. 2 may be instantiated (e.g., creating an instance of, bring into being for any length of time, materialize, implement, etc.) by (i) an Application Specific Integrated Circuit (ASIC) and/or (ii) a Field Programmable Gate Array (FPGA) structured and/or configured in response to execution of second instructions to perform operations corresponding to the first instructions. It should be understood that some or all of the circuitry of FIG. 2 may, thus, be instantiated at the same or different times. Some or all of the circuitry of FIG. 2 may be instantiated, for example, in one or more threads executing concurrently on hardware and/or in series on hardware. Moreover, in some examples, some or all of the circuitry of FIG. 2 may be implemented by microprocessor circuitry executing instructions and/or FPGA circuitry performing operations to implement one or more virtual machines and/or containers.

In the example of FIG. 2, the model tuner circuitry 205 includes example sparsification initiator circuitry 210, example quantization applier circuitry 215, example neural low-rank search (NLS) trainer circuitry 220, example weight merger circuitry 225, example model generator circuitry 230, and example data storage 235. In the example of FIG. 2, the sparsification initiator circuitry 210, the quantization applier circuitry 215, the NLS trainer circuitry 220, the weight merger circuitry 225, the model generator circuitry 230, and the data storage 235 are in communication with an example bus 240.

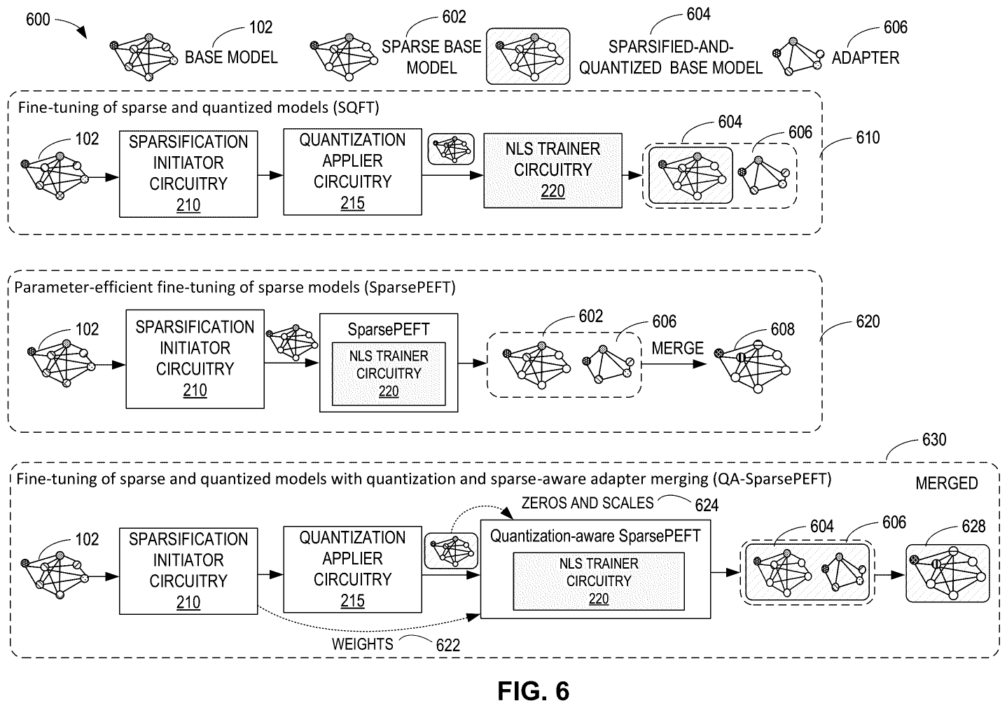

The sparsification initiator circuitry 210 performs sparsification on a base model (e.g., base model 102 of FIG. 1) to obtain a sparse model. For example, the resulting sparse model can serve as a base model for applying a neural low-rank search (NLS) using the NLS trainer circuitry 220. In examples disclosed herein, the sparsification initiator circuitry 210 assigns an arbitrary scoring function (Ψ) to a proposed solution for a given matrix (W), where W∈ [symbol] ^{m×n} and W=(w_{i,j}), 1≤i≤m, 1≤j≤n, for entries w_{i,j}. This function obtains the importance of w_{i,j} relative to the other weights in W. In examples disclosed herein, the scoring function Ψ can be formulated in any given number of ways. In some examples, Ψ(W)=|W|·∥X∥₂, where X represents sampled feature input activations. However, the end-to-end model fine-tuning solution disclosed herein can use any other scoring function. For example, using scores from the scoring function Ψ and a desired level of sparsity (s), the sparsification initiator circuitry 210 obtains a given matrix (W^{p}) with a sparsity pattern that corresponds to S{W^{p}}={(i, j)|W_{i,j}^{p}≠0, 1≤i≤m, 1≤j≤n}, subject to |S{W^{p}}|≤|S{W}|. As described in connection with FIG. 6, the sparsification initiator circuitry 210 performs sparsification of the base model 102 not depending on whether the sparse base model is subsequently used in a first pipeline for fine-tuning of sparse and quantized models, a second pipeline for parameter-efficient fine-tuning of sparse models, and/or a third pipeline for fine-tuning of sparse and quantized models with quantization and sparse-aware adapter merging. As described in connection with examples disclosed herein, large pre-trained models (LPMs) can tolerate higher sparsity levels compared with previous generations of smaller transformer-based models.

The quantization applier circuitry 215 performs quantization of the sparsified weights. For example, the quantization applier circuitry 215 quantizes the sparsified weights (W^{p}) to a lower precision to alleviate memory bandwidth challenges. As such, once the sparsification initiator circuitry 210 has induced sparsity in the pre-trained weights, an optional reduction in the numerical precision of those weights can be performed using the quantization applier circuitry 215. In the example of FIG. 6, the quantization applier circuitry 215 performs quantization of the sparse base model(s) in the first pipeline for fine-tuning of sparse and quantized models and in the third pipeline for fine-tuning of sparse and quantized models with quantization and sparsity-aware adapter merging, but not in the second pipeline for parameter-efficient fine-tuning of sparse models. In some examples, the quantization applier circuitry 215 applies a layer-wise one-shot quantization. For example, using a selection from state-of-the-art post-training quantization approaches, the quantization applier circuitry 215 identifies the low-precision sparsified weights (Ŵ^{p}) that, given an input X, minimize argmin_{Ŵ}_{^{p}}∥W^{p}X-Ŵ^{p}X∥₂². However, reducing the numerical precision and inducing sparsity on weights frequently decreases the model's accuracy, requiring fine-tuning to improve performance (e.g., using the NLS trainer circuitry 220).

In some examples, the quantization applier circuitry 215 performs quantization in connection with the quantization and sparsity-aware parameter-efficient fine-tuning (QA-SparsePEFT) pipeline, as shown in connection with FIG. 6, which represents an extension of sparse parameter-efficient fine-tuning (SparsePEFT) for sparse quantized models. In examples disclosed herein, QA-SparsePEFT integrates quantization awareness into SparsePEFT. In most common quantization schemes, zeros and scales for the target quantized tensor can be determined during the quantization process. Within the framework of QA-SparsePEFT, the zeros and scales of the sparse quantized weights (Ŵ^{p}) are shared with the adapter (e.g., adapter 606 of FIG. 6). For example, the quantization applier circuitry 215 quantizes the adapters with the shared fixed zeros and scales, resulting in quantization-aware fine-tuning. For example, given the sparsified pre-trained weight (W^{p}), sparsified adapter weight (L^{p}) (e.g., obtained from SparsePEFT), and zeros z and scales s from the quantization of W^{p}, the quantization applier circuitry 215 performs the quantization process in accordance with Equation 1:

$${\hat{W}}_{m}^{p} = clamp ( round ( \frac{( {W}^{p} + {L}^{p} )}{s} ) + z , 0 , {Q}_{p} ) ) \qquad Equation 1$$

In the example of Equation 1, Ŵₘ^{p} corresponds to the sparse quantized (e.g., merged) weight, while Qₚ=2ⁿ⁻¹−1, where n represents the bit-width of the quantized values. Conversely, the quantization applier circuitry 215 can perform dequantization in accordance with Equation 2:

$${\tilde{W}}_{m}^{p} = s ( {\tilde{W}}_{m}^{p} - z ) \qquad Equation 2$$

In the example of Equation 2, zeros z and scales s are applied to approximate Wₘ^{p}. In some examples, the NLS trainer circuitry 220 can proceed with NLS training at the same time, allowing for the merging of adapters once an optimal configuration is identified.

The NLS trainer circuitry 220 trains a collection of adapters with variable configurations. For example, given the sparse quantized weights (Ŵ^{p}), the NLS trainer circuitry 220 recovers any drops in accuracy resulting from compression and fine-tunes the weights for a specific downstream task. Unlike NLS, traditional LoRA adapters require assigning values for several hyperparameters, including an associated rank (r), and/or the subset of modules where these adapters will be placed. In examples disclosed herein, the NLS trainer circuitry 220 extends weight-sharing techniques to facilitate the discovery of optimal adapter configurations from a space of elastic adapter configurations. For example, instead of having a fixed value for the rank (r), the NLS trainer circuitry 220 applies elastic configurations, C=[c₁, . . . , cₙ], subject to r←cᵢ, depending on the activation of the corresponding sub-adapter. In some examples, the NLS trainer circuitry 220 can also instantiate an arbitrary configuration from a design space of possible configurations. For example, adapters can be fine-tuned using techniques in weight-sharing super-networks, such that W^{p}←SparsityAndQuantization(W), where L_{δ1} ∈ [symbol] ^{h×{s}^{₀}^{, . . . , s}^{ₙ}^{}}←L₁∈ [symbol] ^{h×r} and L_{δ2} ∈ [symbol] ^{h×{p}^{₀}^{, . . . , p}^{ₘ}^{}}←L₂∈ [symbol] ^{r×o}. As such, L_{δ1} and L_{δ2} represent elastic adapters that can take different configurations without requiring more storage than their static counterparts (e.g., L₁ and L₂).

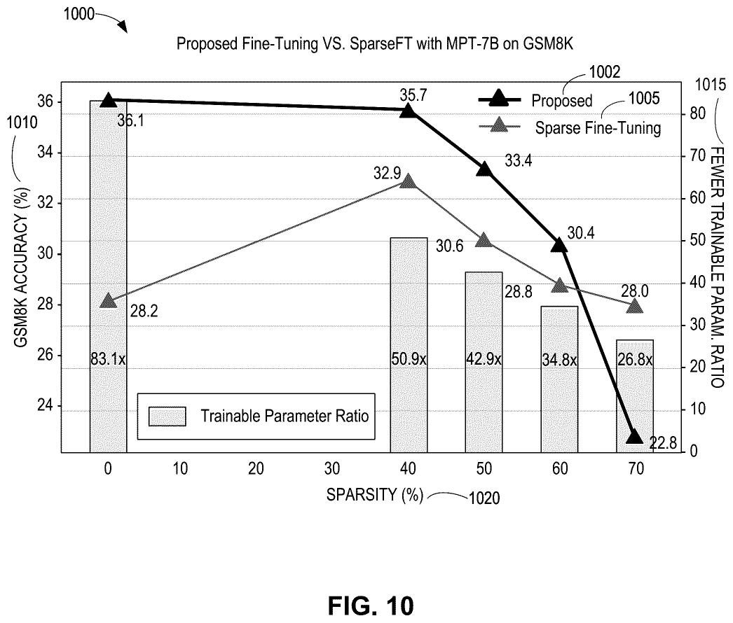

The weight merger circuitry 225 identifies a binary mask from the sparsified weights and applies the binary mask to the adapters, allowing for subsequent merging of the adapters without loss of sparsity. As described in more detail in connection with FIG. 9, SparsePEFT applies a binary mask (M) derived from the initial sparsification of matrix W. For example, the weight merger circuitry 225 applies the binary mask to sparsify the adapters-based matrix (e.g., denoted as BA) into an adapter weight (L^{p}), where the adapter weight is determined using L^{p}=(BA)⊙M and activated during the fine-tuning process for sparsity awareness. In examples disclosed herein, the weight merger circuitry 225 merges the sparsified weights (W^{p}) and the adapter weight (L^{p}) without sacrificing the sparsity induced early in the compression pipeline (e.g., W^{p}←W^{p}+L^{p}). As described in connection with FIG. 9, SparsePEFT demonstrates improved accuracy when compared to fine-tuning with dense adapters.

The model generator circuitry 230 generates the final model resulting from the merging of adapters. While accelerating model serving and inference through sparsification and quantization techniques shows significant efficacy across various hardware platforms and kernels, for parameter-efficient fine-tuning with a sparsified or quantized models, the addition of adapter models introduces computational overhead during inference due to adapter model non mergeability. As previously described in connection with the weight merger circuitry 225, adapters can be merged into the sparse and/or quantized model, reducing the adapters' redundancy and computational overhead, resulting in more streamlined inference processes. The model generator circuitry 230 outputs the final merged model resulting from the merger of (1) a sparse base model and adapter(s) or (2) a sparsified-and-quantized base model and the adapter(s), as described in more detail in connection with FIG. 6.

The data storage 235 can be used to store any information associated with the sparsification initiator circuitry 210, the quantization applier circuitry 215, the NLS trainer circuitry 220, the weight merger circuitry 225, and/or the model generator circuitry 230. The data storage 235 of the illustrated example of FIG. 2 can be implemented by any memory, storage device and/or storage disc for storing data such as flash memory, magnetic media, optical media, etc. Furthermore, the data stored in the data storage 235 can be in any data format such as binary data, comma delimited data, tab delimited data, structured query language (SQL) structures, image data, etc.

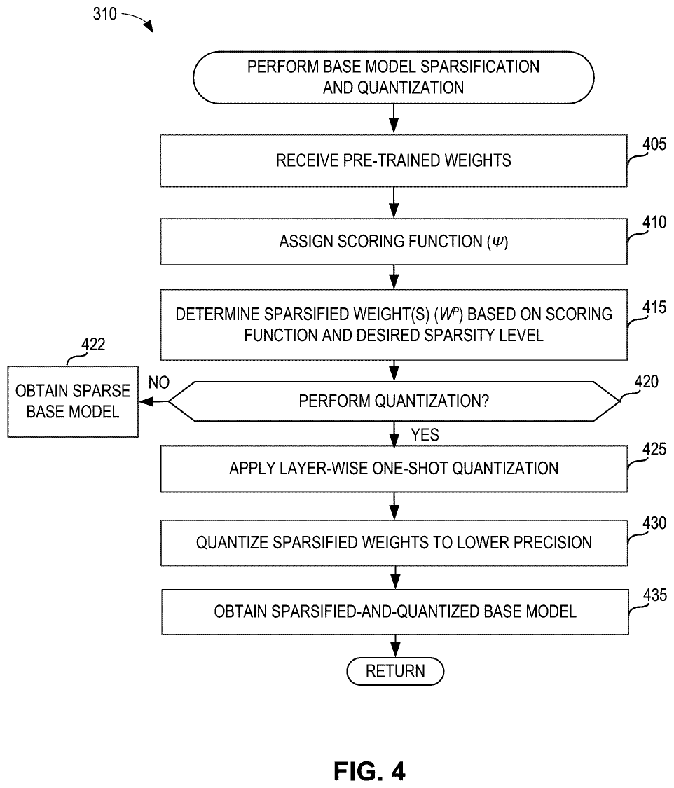

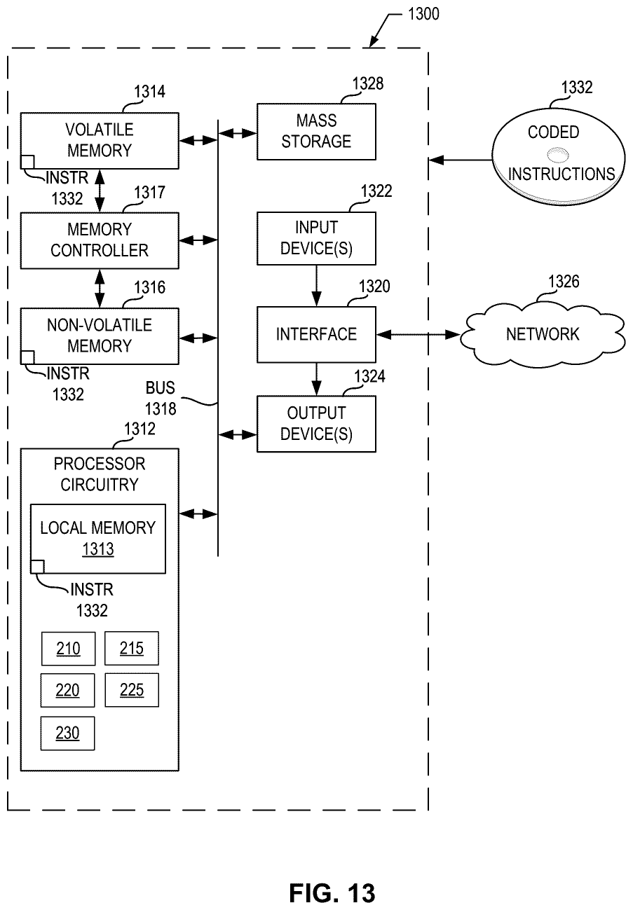

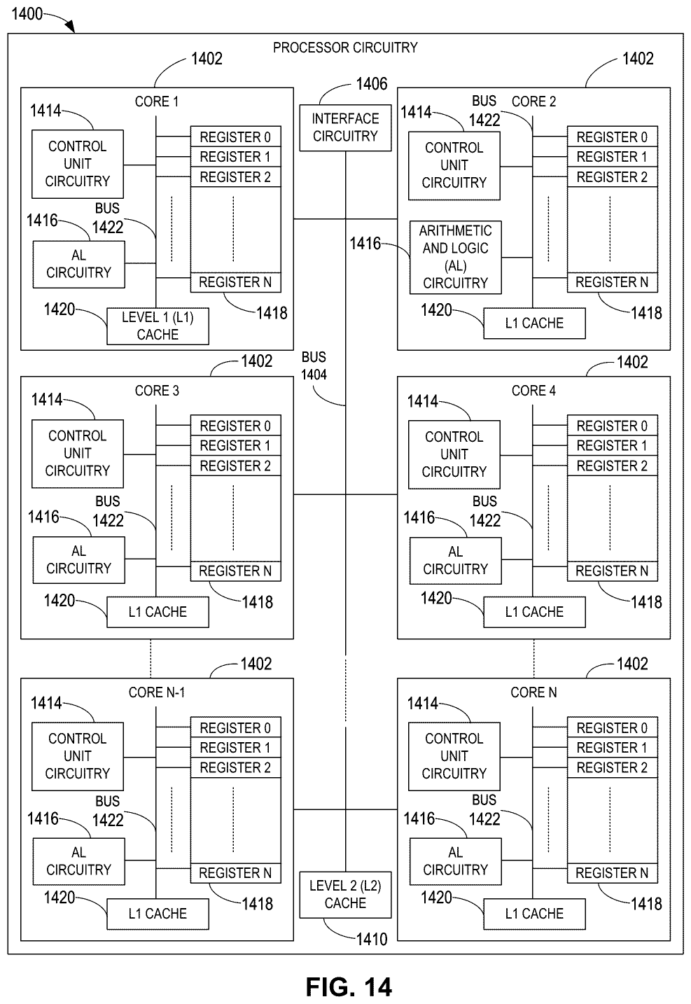

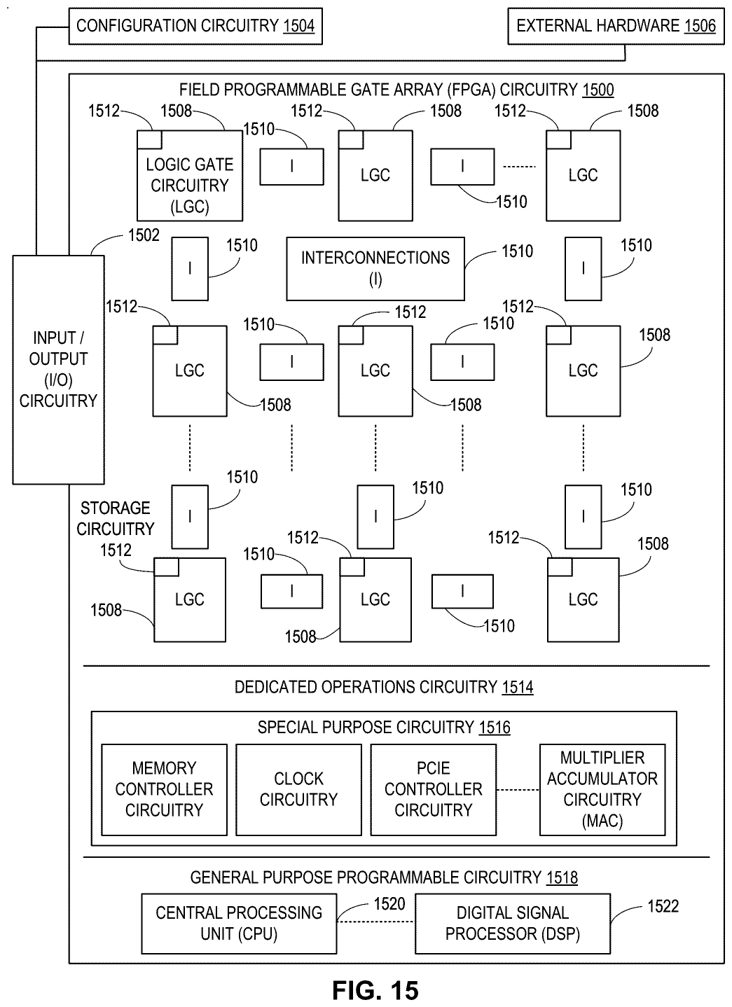

In some examples, the apparatus includes means for sparsifying a base model. For example, the means for sparsifying a base model may be implemented by sparsification initiator circuitry 210. In some examples, the sparsification initiator circuitry 210 may be instantiated by programmable circuitry such as the example programmable circuitry 1312 of FIG. 13. For instance, the sparsification initiator circuitry 210 may be instantiated by the example microprocessor 1400 of FIG. 14 executing machine executable instructions such as those implemented by at least blocks 405, 410, and/or 415 of FIG. 4. In some examples, the sparsification initiator circuitry 210 may be instantiated by hardware logic circuitry, which may be implemented by an ASIC, XPU, or the FPGA circuitry 1500 of FIG. 15 structured to perform operations corresponding to the machine readable instructions. Additionally or alternatively, the sparsification initiator circuitry 210 may be instantiated by any other combination of hardware, software, and/or firmware. For example, the sparsification initiator circuitry 210 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

In some examples, the apparatus includes means for performing quantization. For example, the means for performing quantization may be implemented by quantization applier circuitry 215. In some examples, the quantization applier circuitry 215 may be instantiated by programmable circuitry such as the example programmable circuitry 1312 of FIG. 13. For instance, the quantization applier circuitry 215 may be instantiated by the example microprocessor 1400 of FIG. 14 executing machine executable instructions such as those implemented by at least blocks 420, 425, and/or 430 of FIG. 4. In some examples, the quantization applier circuitry 215 may be instantiated by hardware logic circuitry, which may be implemented by an ASIC, XPU, or the FPGA circuitry 1500 of FIG. 15 structured to perform operations corresponding to the machine readable instructions. Additionally or alternatively, the quantization applier circuitry 215 may be instantiated by any other combination of hardware, software, and/or firmware. For example, the quantization applier circuitry 215 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

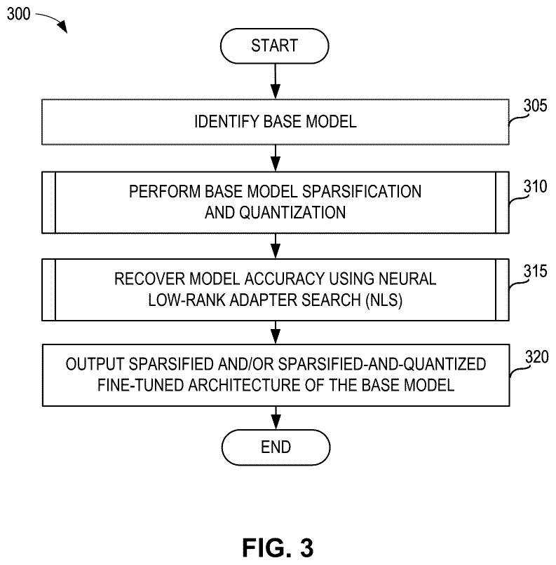

In some examples, the apparatus includes means for applying a neural low-rank adapter search. For example, the means for applying a neural low-rank adapter search may be implemented by the neural low-rank search (NLS) trainer circuitry 220. In some examples, the NLS trainer circuitry 220 may be instantiated by programmable circuitry such as the example programmable circuitry 1312 of FIG. 13. For instance, the NLS trainer circuitry 220 may be instantiated by the example microprocessor 1400 of FIG. 14 executing machine executable instructions such as those implemented by at least block 315 of FIG. 3. In some examples, the NLS trainer circuitry 220 may be instantiated by hardware logic circuitry, which may be implemented by an ASIC, XPU, or the FPGA circuitry 1500 of FIG. 15 structured to perform operations corresponding to the machine readable instructions. Additionally or alternatively, the NLS trainer circuitry 220 may be instantiated by any other combination of hardware, software, and/or firmware. For example, the NLS trainer circuitry 220 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

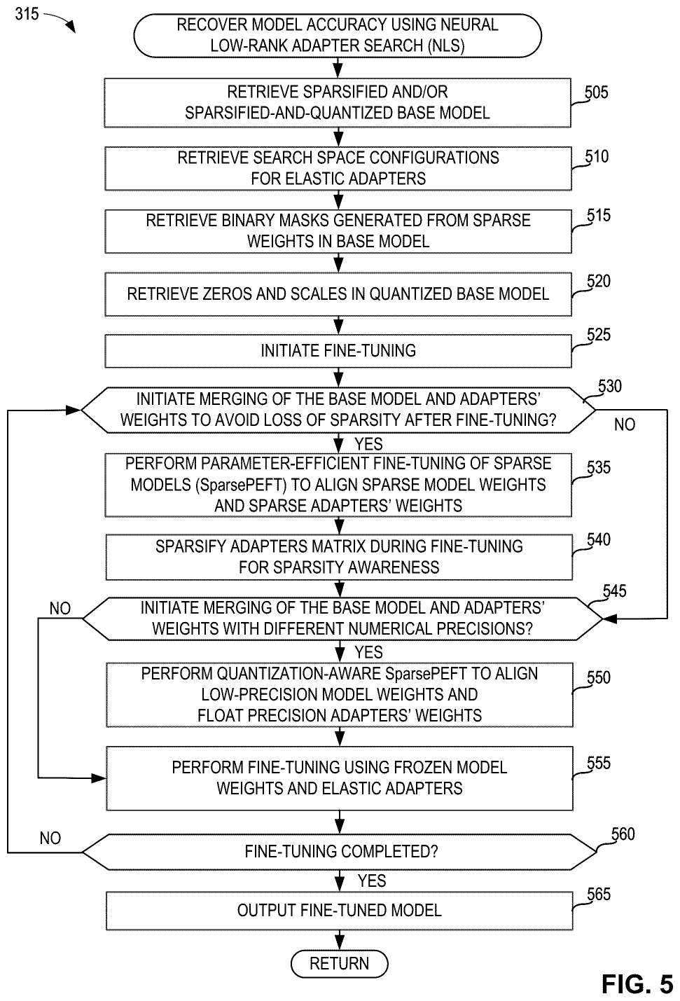

In some examples, the apparatus includes means for weight merging. For example, the means for weight merging may be implemented by the weight merger circuitry 225. In some examples, the weight merger circuitry 225 may be instantiated by programmable circuitry such as the example programmable circuitry 1312 of FIG. 13. For instance, the weight merger circuitry 225 may be instantiated by the example microprocessor 1400 of FIG. 14 executing machine executable instructions such as those implemented by at least block 520 of FIG. 5. In some examples, the weight merger circuitry 225 may be instantiated by hardware logic circuitry, which may be implemented by an ASIC, XPU, or the FPGA circuitry 1500 of FIG. 15 structured to perform operations corresponding to the machine readable instructions. Additionally or alternatively, the weight merger circuitry 225 may be instantiated by any other combination of hardware, software, and/or firmware. For example, the weight merger circuitry 225 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

In some examples, the apparatus includes means for outputting a fine-tuned base model. For example, the means for outputting a fine-tuned base model may be implemented by the model generator circuitry 230. In some examples, the model generator circuitry 230 may be instantiated by programmable circuitry such as the example programmable circuitry 1312 of FIG. 13. For instance, the model generator circuitry 230 may be instantiated by the example microprocessor 1400 of FIG. 14 executing machine executable instructions such as those implemented by at least block 320 of FIG. 3. In some examples, the model generator circuitry 230 may be instantiated by hardware logic circuitry, which may be implemented by an ASIC, XPU, or the FPGA circuitry 1500 of FIG. 15 structured to perform operations corresponding to the machine readable instructions. Additionally or alternatively, the model generator circuitry 230 may be instantiated by any other combination of hardware, software, and/or firmware. For example, the model generator circuitry 230 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

While an example manner of implementing the model tuner circuitry 205 is illustrated in FIG. 2, one or more of the elements, processes and/or devices illustrated in FIG. 2 may be combined, divided, re-arranged, omitted, eliminated and/or implemented in any other way. Further, the example sparsification initiator circuitry 210, the example quantization applier circuitry 215, the example NLS trainer circuitry 220, the example weight merger circuitry 225, the example model generator circuitry 230, and/or, more generally, the model tuner circuitry 205 of FIG. 2 may be implemented by hardware, software, firmware and/or any combination of hardware, software and/or firmware. Thus, for example, any of the example sparsification initiator circuitry 210, the example quantization applier circuitry 215, the example NLS trainer circuitry 220, the example weight merger circuitry 225, the example model generator circuitry 230, and/or, more generally, the model tuner circuitry 205 of FIG. 2 could be implemented by programmable circuitry in combination with machine readable instructions (e.g., firmware or software), processor circuitry, analog circuit(s), digital circuit(s), logic circuit(s), programmable processor(s), programmable microcontroller(s), graphics processing unit(s) (GPU(s)), digital signal processor(s) (DSP(s), ASIC(s)), programmable logic device(s) (PLD(s)), and/or field programmable logic device(s) (FPLD(s)) such as FPGAs. Further still, the model tuner circuitry 205 of FIG. 2 may include one or more elements, processes, and/or devices in addition to, or instead of, those illustrated in FIG. 2, and/or may include more than one of any or all of the illustrated elements, processes and devices.

Flowcharts representative of example machine readable instructions, which may be executed by programmable circuitry to implement and/or instantiate the model tuner circuitry 205 of FIG. 2 and/or representative of example operations which may be performed by programmable circuitry to implement and/or instantiate the model tuner circuitry 205 of FIG. 2, are shown in FIGS. 3-5. The machine readable instructions may be one or more executable programs or portion(s) of one or more executable programs for execution by programmable circuitry, such as the programmable circuitry 1312 shown in the example processor platform 1300 discussed below in connection with FIG. 13 and/or may be one or more function(s) or portion(s) of functions to be performed by the example programmable circuitry (e.g., an FPGA) discussed below in connection with FIGS. 14 and/or 15. In some examples, the machine readable instructions cause an operation, a task, etc., to be carried out and/or performed in an automated manner in the real world. As used herein, “automated” means without human involvement.

The program may be embodied in instructions (e.g., software and/or firmware) stored on one or more non-transitory computer readable and/or machine readable storage medium such as cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically erasable programmable read-only memory (EEPROM), flash memory, etc.), volatile memory (e.g., Random Access Memory (RAM) of any type, etc.), and/or any other storage device or storage disk. The instructions of the non-transitory computer readable and/or machine readable medium may program and/or be executed by programmable circuitry located in one or more hardware devices, but the entire program and/or parts thereof could alternatively be executed and/or instantiated by one or more hardware devices other than the programmable circuitry and/or embodied in dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a human and/or machine user) or an intermediate client hardware device gateway (e.g., a radio access network (RAN)) that may facilitate communication between a server and an endpoint client hardware device. Similarly, the non-transitory computer readable storage medium may include one or more mediums. Further, although the example program is described with reference to the flowcharts illustrated in FIGS. 3-5, many other methods of implementing the example model tuner circuitry 205 of FIG. 2 may alternatively be used. For example, the order of execution of the blocks of the flowchart(s) may be changed, and/or some of the blocks described may be changed, eliminated, or combined. Additionally or alternatively, any or all of the blocks of the flow chart may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The programmable circuitry may be distributed in different network locations and/or local to one or more hardware devices (e.g., a single-core processor (e.g., a single core CPU), a multi-core processor (e.g., a multi-core CPU, an XPU, etc.)). For example, the programmable circuitry may be a CPU and/or an FPGA located in the same package (e.g., the same integrated circuit (IC) package or in two or more separate housings), one or more processors in a single machine, multiple processors distributed across multiple servers of a server rack, multiple processors distributed across one or more server racks, etc., and/or any combination(s) thereof.

The machine readable instructions described herein may be stored in one or more of a compressed format, an encrypted format, a fragmented format, a compiled format, an executable format, a packaged format, etc. Machine readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, and/or produce machine executable instructions. For example, the machine readable instructions may be fragmented and stored on one or more storage devices, disks and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of computer-executable and/or machine executable instructions that implement one or more functions and/or operations that may together form a program such as that described herein.

In another example, the machine readable instructions may be stored in a state in which they may be read by programmable circuitry, but require addition of a library (e.g., a dynamic link library (DLL)), a software development kit (SDK), an application programming interface (API), etc., in order to execute the machine-readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable, computer readable and/or machine readable media, as used herein, may include instructions and/or program(s) regardless of the particular format or state of the machine readable instructions and/or program(s).

The machine readable instructions described herein can be represented by any past, present, or future instruction language, scripting language, programming language, etc. For example, the machine readable instructions may be represented using any of the following languages: C, C++, Java, C#, Perl, Python, JavaScript, HyperText Markup Language (HTML), Structured Query Language (SQL), Swift, etc.

As mentioned above, the example operations of FIGS. 3-5 may be implemented using executable instructions (e.g., computer readable and/or machine readable instructions) stored on one or more non-transitory computer readable and/or machine readable media. As used herein, the terms non-transitory computer readable medium, non-transitory computer readable storage medium, non-transitory machine readable medium, and/or non-transitory machine readable storage medium are expressly defined to include any type of computer readable storage device and/or storage disk and to exclude propagating signals and to exclude transmission media. Examples of such non-transitory computer readable medium, non-transitory computer readable storage medium, non-transitory machine readable medium, and/or non-transitory machine readable storage medium include optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms “non-transitory computer readable storage device” and “non-transitory machine readable storage device” are defined to include any physical (mechanical, magnetic and/or electrical) hardware to retain information for a time period, but to exclude propagating signals and to exclude transmission media. Examples of non-transitory computer readable storage devices and/or non-transitory machine readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine readable instructions, etc., and/or manufactured to execute computer-readable instructions, machine-readable instructions, etc.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/of” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities and/or steps, the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities and/or steps, the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

FIG. 3 is a flowchart representative of example machine readable instructions and/or example operations 300 that may be executed, instantiated, and/or performed by programmable circuitry to implement the example model tuner circuitry of FIG. 2. The machine-readable instructions and/or the operations 300 of FIG. 3 begin at block 305, at which the sparsification initiator circuitry 210 identifies the base model and proceeds to perform base model sparsification, at block 310, as described in more detail in connection with FIG. 4. Once model sparsification and/or model quantization is completed, the NLS trainer circuitry 220 recovers model accuracy using neural low-rank adapter search, at block 315, as described in more detail in connection with FIG. 5. Following recovery of model accuracy, the model generator circuitry 230 outputs the sparsified and/or sparsified-and-quantized fine-tuned architecture of the initial input base model, at block 320. For example, the model generator circuitry 230 outputs the final merged model resulting from the merger of (1) a sparse base model and corresponding adapter(s) or (2) a sparsified-and-quantized base model and the corresponding adapter(s), as described in more detail in connection with FIG. 6.

FIG. 4 is a flowchart representative of example machine readable instructions and/or example operations 310 that may be executed, instantiated, and/or performed by programmable circuitry to implement the example model tuner circuitry 205 of FIG. 2 to perform base model sparsification and quantization. The machine-readable instructions and/or the operations 310 of FIG. 3 begin at block 405, at which the sparsification initiator circuitry 210 receives pre-trained weights and proceeds to assign an arbitrary scoring function (Ψ) based, for example, on sampled feature input activations, at block 410. The sparsification initiator circuitry 210 determines sparsified weight(s) (W^{p}) based on the arbitrary scoring function and a desired level of sparsity, at block 415. Subsequently, the quantization applier circuitry 215 determines whether to perform quantization, at block 420. For example, if the quantization applier circuitry 215 determines that quantization is not needed (e.g., when performing parameter-efficient fine-tuning of sparse models), the sparsification initiator circuitry 210 outputs the sparse base model, at block 422. In some examples, quantization is initiated as part of fine-tuning of sparse and quantized models or as part of fine-tuning of sparse and quantized models with quantization and sparse-aware adapter merging. In such examples, the quantization applier circuitry 215 applies layer-wise one-shot quantization, at block 425. The quantization applier circuitry 215 then quantizes the sparsified weights to a lower precision to alleviate memory bandwidth challenges, at block 430, resulting in a sparsified-and-quantized base model, at block 435.

FIG. 5 is a flowchart representative of example machine readable instructions and/or example operations 315 that may be executed, instantiated, and/or performed by programmable circuitry to implement the example model tuner circuitry 205 of FIG. 2 to recover model accuracy using neural low-rank adapter search (NLS). The machine-readable instructions and/or the operations 315 of FIG. 3 begin at block 505, at which the NLS trainer circuitry 220 retrieves the sparsified and/or sparsified-and-quantized base model and retrieves search space configurations for elastic adapters, at block 510. In some examples, the NLS trainer circuitry 220 fine-tunes adapters using techniques in weight-sharing super-networks, as described in connection with FIG. 2. After NLS training, if the weight merger circuitry 225 determines that sparsified weights and adapter weights are to be merged, the weight merger circuitry 225 generates a binary mask derived from an initial sparsification of the weight matrix (W). For example, as previously described in more detail in connection with FIG. 2, the weight merger circuitry 225 applies the binary mask to the adapters, allowing for subsequent merging of the adapters without loss of sparsity. In the example of FIG. 5, the NLS trainer circuitry 220 retrieves the binary mask(s) generated from sparse weights in a base model, at block 515. In the example of FIG. 5, the quantization applier circuitry 215 retrieves zeros and scales associated with a quantized base model, at block 520. In some examples, the model generator circuitry 230 initiates fine-tuning of the model(s), at block 525. For example, as part of fine-tuning, the weight merger circuitry 225 determines whether to initiate merging of the base model and adapters' weights to avoid loss of sparsity after fine-tuning, at block 530. If the weight merger circuitry 225 initiates merging of the base model and adapters' weights, control proceeds to block 535, at which the weight merger circuitry 225 aligns sparse model weights and sparse adapters' weights as part of the parameter efficient fine-tuning of sparse models (SparsePEFT). In some examples, the sparsification initiator circuitry 210 sparsifies the adapters matrix during fine-tuning to achieve sparsity awareness, at block 540.

Once the base model and adapters' weights are merged and/or if the weight merger circuitry 225 determines not to initiate merging of the base model and adapters' weights, control proceeds to block 545. For example, the weight merger circuitry 225 determines whether to initiate merging of the base model and adapters' weights with different numerical precisions, at block 545. If the weight merger circuitry 225 determines to proceed with the merging of the base model and adapters' weights with different numerical precisions, the quantization applier circuitry 215 performs quantization-aware SparsePEFT (QA-SparsePEFT) to align low-precision model weights and float precision adapters' weights, at block 550. For example, the quantization applier circuitry 215 performs quantization using the sparsified pre-trained weight(s) and sparsified adapter weight(s) as part of the fine-tuning of sparse and quantized models with quantization and sparse-aware adapter merging. In the example of FIG. 5, the model generator circuitry 230 determines whether to perform fine-tuning using frozen model weights and elastic adapters, at block 555. If the model generator circuitry 230 determines that model fine-tuning is completed, at block 560, the model generator circuitry 230 outputs the fine-tuned model, at block 565. If the model generator circuitry 230 determines that additional model fine-tuning is needed based on the generated output, control returns to block 530 until the model fine-tuning process is finalized.

FIG. 6 illustrates example pipeline configurations 600 that can be instantiated to efficiently fine-tune large models, including (1) a first pipeline 610 for parameter-efficient fine-tuning of sparse and quantized models using elastic adapters, resulting in an unmerged model and adapters, (2) a second pipeline 620 for parameter-efficient fine-tuning of sparse models using sparse awareness (SparsePEFT), permitting subsequent merging of the model and adapters, and (3) a third pipeline 630 for parameter-efficient fine-tuning of sparse and quantized models with quantization and sparse-aware adapter merging. While LLM fine-tuning is extensively used to align foundation and/or frontier models to a particular task or dataset, fine-tuning these large models is a resource-intensive endeavor. In the example of FIG. 6, fine-tuning of sparse and quantized models (SQFT) results in fine-tuned large pre-trained model(s) (LPMs) that are obtained in an efficient multi-stage approach including (1) sparsification, with an optional reduction in numerical precision (e.g., quantization), (2) a neural low-rank adapter search (NLS), and (3) sparse parameter-efficient fine-tuning (SparsePEFT), with optional quantization awareness (QA-SparsePEFT). In the example of FIG. 6, alternative LPM compression and model adaptation pipelines 610, 620, 630 can be selected based on whether to apply quantization and/or sparse-awareness adapter merging. For example, the choice between the sparsity level and whether to apply quantization can depend on the specific deployment scenario (e.g., task requirements, resource constraints, etc.), including anticipated trade-offs between model performance, inference speed, and/or memory efficiency.

In the example of FIG. 6, the first pipeline 610 for fine-tuning of sparse and quantized models (SQFT) involves identification of a base model 102 by the sparsification initiator circuitry 210 of FIG. 2, which performs model sparsification. The quantization applier circuitry 215 proceeds to quantize the sparse model, resulting in a sparsified-and-quantized base model 604, which is processed using the NLS trainer circuitry 220 to obtain unmerged adapters. However, the sparsified-and-quantized base model 604 and the adapter(s) 606 remain unmerged in the first pipeline 610, while the effective merging of the adapter(s) 606 into the sparse and/or quantized model(s) without loss of sparsity is shown in connection with the second and third pipeline(s) 620, 630. For example, the second pipeline 620 (SparsePEFT), which includes components of the first pipeline 610 (SQFT), addresses several limitations in existing parameter-efficient fine-tuning approaches for sparse and quantized models, including reduction in the cost of fine tuning, effective merging of adapters into the sparse model without the loss of sparsity, and effective merging of components that operate in different numerical precisions. In the example of the second pipeline 620, after the sparse base model 602 is generated and the NLS trainer circuitry 220 performs training to obtain unmerged adapters, the weight merger circuitry 225 identifies a binary mask from the sparsified weights and applies the binary mask to the adapters, allowing for subsequent merging of the adapter(s) 606 without loss of sparsity, resulting in the output of a sparsified fine-tuned architecture 608 of the original base model.

Although SparsePEFT can effectively preserve the model's sparsity, this pipeline presents additional challenges when merging with quantized models, which is primarily attributed to the need for the adapter and pre-trained weights to possess identical numerical precision. In the example of FIG. 6, the third pipeline 630 represents an extension of SparsePEFT for sparse quantized models. For example, the quantization applier circuitry 215 identifies sparsified weights 622 and corresponding zeros and scales 624 of the sparse quantized weights, which are shared with the adapter(s) 606. As such, the quantization applier circuitry 215 quantizes the adapters 606 with the shared fixed zeros and scales, resulting in quantization-aware fine-tuning that yields a sparsified-and-quantized fine-tuned architecture 628 of the original base model.

FIG. 7 illustrates an example comparison 700 of known low-rank (LoRA) adapters to elastic adapters associated with a neural low-rank search (NLS) disclosed herein. For example, LoRA adapters are associated with parameter-efficient fine-tuning techniques used for modifying a selection of linear layers, each having a weight matrix (e.g., W₀∈ [symbol] ^{d×k}). In some examples, LoRA adapters (e.g., a first adapter A, where A∈ [symbol] ^{r×k} and a second adapter B, where B× [symbol] ^{d×r}) are utilized to extend the layer's linear projection (e.g., extending the projection from H=W₀X to H=W₀X+BAX), such that the original model's weights (W₀) can be kept frozen, and only the inserted adapters are fine-tuned. Whereas the original LoRA adapters of FIG. 7 include the use of a first rank 705, where the rank is maintained at the same level (e.g., r=32), NLS-based LoRA adapters are elastic adapters with variable ranks, such that the ranks (e.g., second rank 710, third rank 715) can be modified as needed. For example, instead of having a fixed value for the rank (r), the NLS trainer circuitry 220 applies elastic configurations depending on the activation of the corresponding sub-adapter, as described in more detail in connection with FIG. 2. The elastic LoRA adapters using variable ranking as described herein outperform traditional LoRA adapters.

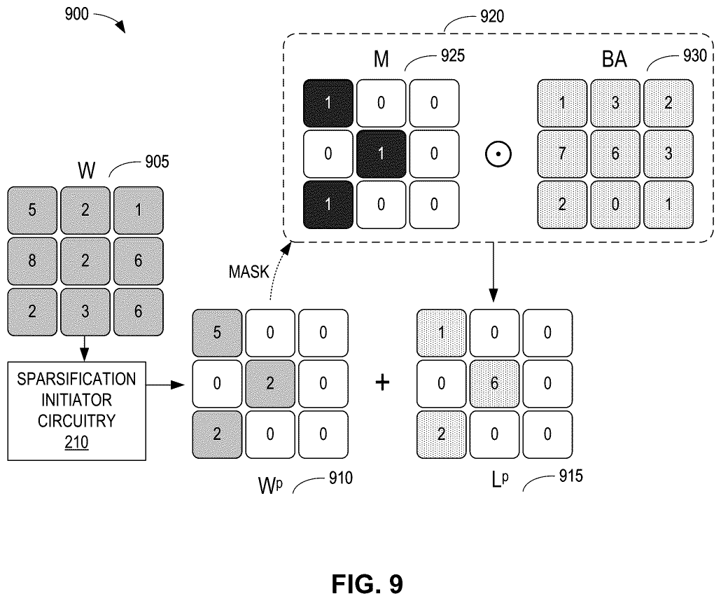

FIG. 8 illustrates an example overview 800 of fine-tuning pre-trained LLMs based on model sparsification, recovery of base model accuracy using the NLS adapters of FIG. 7, and identification of a sparsified fine-tuned architecture based on a sub-adapter search. In the example of FIG. 8, for a given matrix (W) 805, the sparsification initiator circuitry 210 of FIG. 2 identifies sparsified weights (W^{p}) 810. The sparsification initiator circuitry 210 receives the original weights matrix 815 of dense model weights and applies an arbitrary scoring function (Ψ) 820 to select the most critical weights, resulting in a sparse output matrix 825. The quantization applier circuitry 215 performs quantization of the sparsified weights while the NLS trainer circuitry 220 combines pre-trained weights 830 of the sparse model with a collection of elastic adapters 835 trained with variable configurations. As described in connection with FIG. 7, the NLS trainer circuitry 220 applies elastic configurations of adapters, as determined based on activation of a corresponding sub-adapter 840, such that the rank is varied to facilitate identification of optimal adapter configurations from a space of elastic adapter configurations.

FIG. 9 illustrates sparse parameter-efficient fine-tuning (SparsePEFT) 900 using a binary mask obtained from sparsified weights. For example, as described in connection with FIG. 2, the weight merger circuitry 225 identifies a binary mask from the sparsified weights and applies the binary mask to the adapters, allowing for subsequent merging of the adapters without loss of sparsity. In the example of FIG. 9, the sparsification initiator circuitry 210 receives a matrix (W) 905 and identifies sparsified weights (W^{p}) 910. The weight merger circuitry 225 performs adapter weight identification 920 by applying a binary mask (M) 925 to sparsify the adapters matrix (e.g., denoted as BA 930) into an adapter weight (L^{p}) 915, such that the adapter weight 915 is identified using L^{p}=(BA)⊙M. The weight merger circuitry 225 merges the sparsified weights (W^{p}) 910 and the adapter weight (L^{p}) 915 without sacrificing the sparsity induced early in the compression pipeline.

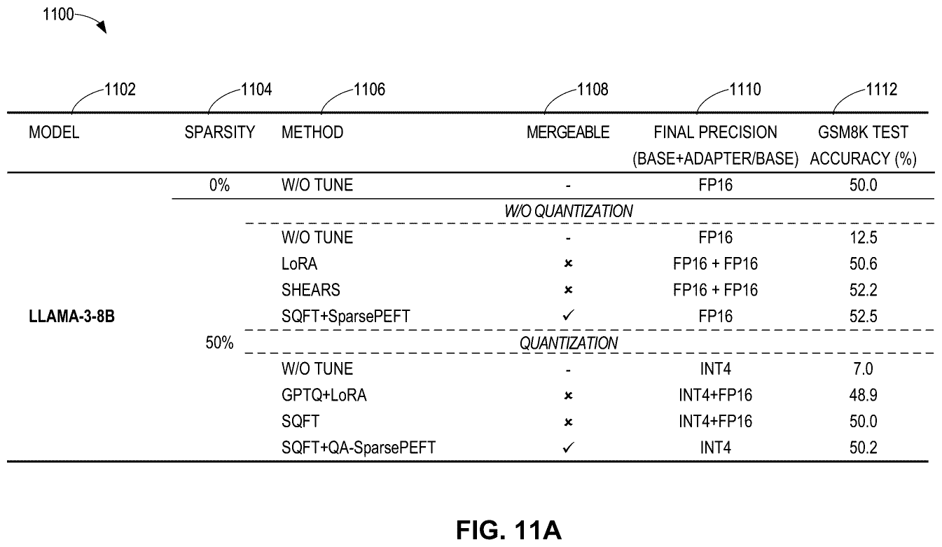

FIG. 10 illustrates an example reduction of parameters 1000 needed to fine-tune an LLM while obtaining higher accuracy using methods disclosed herein, as compared to known sparse fine-tuning methods. In the example of FIG. 10, fine-tuning methods and apparatus disclosed herein (e.g., proposed solution 1002) are compared with a known method for fine-tuning models (e.g., sparse fine-tuning 1005 from Neural Magic). For example, the SQFT pipeline (e.g., first pipeline 610 of FIG. 6) is validated on three experimental settings, including Grade School Math 8K (GSM8K), shown in the example of FIG. 10. The proposed solution 1002 is compared to sparse fine-tuning 1005 using measurements of GSM8K accuracy (%) 1010, trainable parameter ratio 1015, and sparsity (%) 1020. In the example of FIG. 10, the proposed solution 1002 requires approximately 83.1 times fewer parameters to perform fine-tuning, while obtaining a higher accuracy, as compared to sparse fine-tuning 1005.

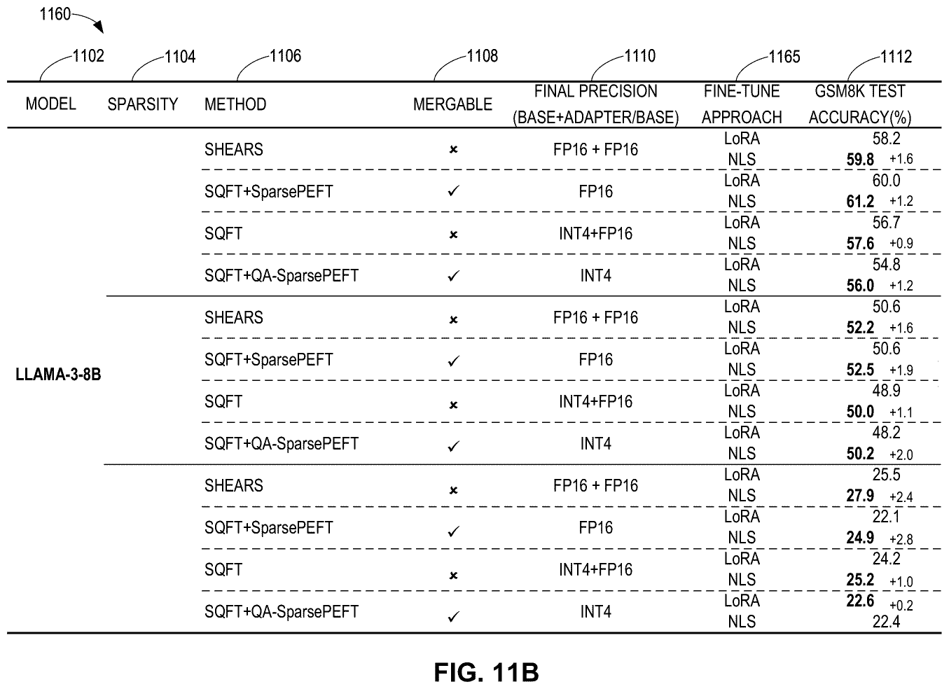

FIG. 11A illustrates example results 1100 for evaluating fine-tuning of an example first model 1102 (e.g., LLAMA-3-8B) using known fine-tuning as compared to approaches disclosed herein (e.g., fine-tuning of sparce and quantized models (SQFT), SQFT in combination with SparsePEFT, and SQFT in combination with SparsePEFT including quantization and sparse-aware adapter merging (QA-SparsePEFT)). In examples disclosed herein, SQFT is evaluated on several state-of-the-art large pre-trained models and datasets. For example, SQFT is evaluated using Llama-3-8B and Phi-3-Mini-4K-Instruct. In examples disclosed herein, SQFT is validated on three experimental settings: 1) Grade School Math 8K (GSM8K), 2) Math reasoning with instruction tuning, including three math reasoning datasets (e.g., GSM8K, Math word problems, Simple Variations on Arithmetic Mathword Problems (SVAMP)), and 3) Commonsense reasoning datasets (e.g., Boolean Questions (BoolQ), Physical Interaction: Question Answering (PIQA), Largescale Winograd Schema Challenge (WinoGrande), AI2 Reasoning Challenges (Arc-e, Arc-c), and Open Book Question Answering (OBQA)). In examples disclosed herein, a comparative analysis of the results obtained using the disclosed pipelines (e.g., first pipeline 610, second pipeline 620, and/or third pipeline 630 of FIG. 6) is presented and compared with vanilla low-rank (LoRA) adapters, Shears (e.g., a parameter-efficient fine-tuning method for sparse models), and GPTQ+LoRA, where all methods are run in the same environment and with the same configuration. In examples disclosed herein, SQFT also employs the implementation of Wanda as a default method for sparsification, and GPTQ in Huggingface 3 for quantizing the LPMs and adapters.

In the example of FIG. 11A, evaluation of the pipelines (e.g., SQFT and SQFT+QA-SparsePEFT) is performed using Llama-3-8B, assessing accuracy in a dense mode and after inducing 50% sparsity without fine-tuning on the GSM8K dataset. In the example of FIG. 11A, results include a level of induced sparsity 1104, a selection of the pipeline method 1106, mergeability results 1108, final precision results 1110, and GSM8K test accuracy percentage results 1112. For example, SQFT recovers the model's accuracy from 12.5% to 52.5% without employing quantization, while allowing for the merging of adapters without sacrificing sparsity (using SparsePEFT) and further incorporating quantization into the pipeline, resulting in a minor drop in accuracy to 50.2% when enabling the adjustment to merge adapters (using QA-SparsePEFT). Futhermore, SQFT with SparsePEFT and QA-SparsePEFT exhibit comparable performance to their corresponding non-mergeable approaches. These results suggest that SQFT with SparsePEFT (e.g., QA-SparsePEFT) effectively addresses the limitation of the merging problem encountered when fine-tuning adapters into sparse models (or sparse and quantized models) without any degradation in accuracy. Furthermore, the comparison between LoRA and SQFT with SparsePEFT (or Shears), and between GPTQ+LoRA and SQFT with QASparsePEFT without adapter merging, highlights the superior performance of NLS (e.g., performed using elastic ranking) as compared with LoRA (e.g., performed using a fixed rank).

FIG. 11B illustrates example ablation study results 1160 for fine-tuning using known low-rank adapters (LoRA) compared to elastic adapters associated with the neural low-rank search (NLS) of FIG. 7 when evaluating fine-tuning disclosed herein, including SQFT with SparsePEFT and SQFT with quantization-aware SparsePEFT. In the example of FIG. 11B, results for the model 1102 include a level of induced sparsity 1104, a selection of the pipeline method 1106, mergeability results 1108, final precision results 1110, fine-tuning approach selection 1165, and test accuracy percentage results 1112 for specific datasets. In the example of FIG. 11B, NLS demonstrates significantly better accuracy performance compared to LoRA across all pipelines of SQFT and different sparsity levels. For example, ablation studies using 30%, 50%, and 70% sparsity highlight the benefits of elastic adapters (e.g., applied using NLS), which enhance the performance of the SQFT pipeline(s) disclosed herein.

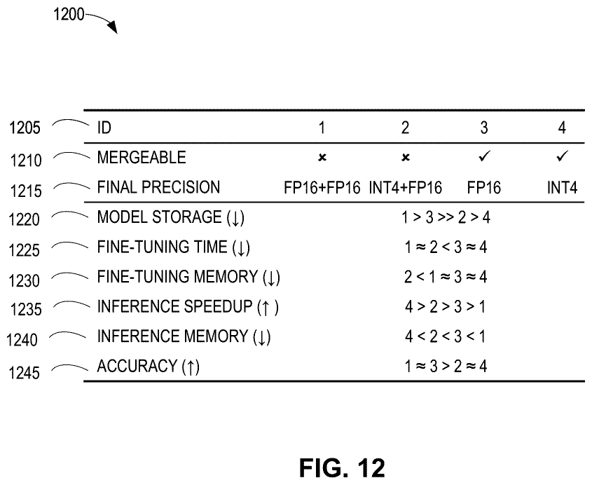

FIG. 12 illustrates example cost analysis 1200 for different pipelines associated with model fine-tuning, including an assessment of model storage, fine-tuning time, and accuracy. In the example of FIG. 12, an identifier 1205 represents different pipelines, where ID=1 corresponds to LoRA/Shears, ID=2 corresponds to SQFT, ID=3 corresponds to SQFT+SparsePEFT, and ID=4 corresponds to SQFT+QA-SparsePEFT, respectively. The different versions of SQFT pipelines incur various costs that allow users to choose based on their fine-tuning budget. The characteristics of each pipeline configuration are detailed in the example of FIG. 12, based on whether adapters can be merged (e.g., mergeable indicator 1210), as well as the final precision of the base model and the adapters (e.g., final precision 1215) and the cost of each configuration. In the example of FIG. 12, model storage 1220, fine-tuning time 1225, fine-tuning memory 1230, inference speedup 1235, inference memory 1240, and accuracy 1245 are compared for all pipeline(s). Regarding model storage, inference speedup, and memory, an assumption can be made that merging is better than unmerging due to overhead from the unmerged adapters and that the quantization mode is better than the full-precision mode. Regarding fine-tuning time, the mergeable method is slightly slower than the non-mergeable method due to additional mask and adapter calculations. Based on the results, SQFT with SparsePEFT is an optimal choice for the full-precision mode without sacrifices in accuracy. If memory usage during fine-tuning is a priority for the quantization mode, vanilla SQFT is the optimal choice due to the use of the quantized model with little overhead associated with different precision adapters. Otherwise, SQFT with QA-SparsePEFT produces a more efficient model as compared to the other fine-tuning pipelines.

FIG. 13 is a block diagram of an example programmable circuitry platform 1300 structured to execute and/or instantiate the example machine-readable instructions and/or the example operations of FIGS. 3-5 to implement the example model tuner circuitry 205 of FIG. 2. The programmable circuitry platform 1300 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing and/or electronic device.

The programmable circuitry platform 1300 of the illustrated example includes programmable circuitry 1312. The programmable circuitry 1312 of the illustrated example is hardware. For example, the programmable circuitry 1312 can be implemented by one or more integrated circuits, logic circuits, FPGAs microprocessors, CPUs, GPUs, DSPs, and/or microcontrollers from any desired family or manufacturer. The programmable circuitry 1312 may be implemented by one or more semiconductor based (e.g., silicon based) devices. In this example, the processor circuitry 1312 implements the sparsification initiator circuitry 210, quantization applier circuitry 215, NLS trainer circuitry 220, weight merger circuitry 225, and/or model generator circuitry 230.

The programmable circuitry 1312 of the illustrated example includes a local memory 1313 (e.g., a cache, registers, etc.). The programmable circuitry 1312 of the illustrated example is in communication with a main memory including a volatile memory 1314 and a non-volatile memory 1316 by a bus 1318. The volatile memory 1314 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 1316 may be implemented by flash memory and/or any other desired type of memory device. Access to the main memory 1314, 1316 of the illustrated example is controlled by a memory controller 1317. In some examples, the memory controller 1317 may be implemented by one or more integrated circuits, logic circuits, microcontrollers from any desired family or manufacturer, or any other type of circuitry to manage the flow of data going to and from the main memory 1314, 1316.

The programmable circuitry platform 1300 of the illustrated example also includes interface circuitry 1320. The interface circuitry 1320 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 1322 are connected to the interface circuitry 1320. The input device(s) 1322 permit(s) a user (e.g., a human user, a machine user, etc.) to enter data and/or commands into the programmable circuitry 1312. The input device(s) 1322 can be implemented by, for example, an audio sensor, a microphone, a camera (still or video), a keyboard, a button, a mouse, a touchscreen, a track-pad, a trackball, an isopoint device, and/or a voice recognition system.

One or more output devices 1324 are also connected to the interface circuitry 1320 of the illustrated example. The output devices 1324 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 1320 of the illustrated example, thus, typically includes a graphics driver card, a graphics driver chip, and/or graphics processor circuitry such as a GPU.

The interface circuitry 1320 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 1326. The communication can be by, for example, an Ethernet connection, a digital subscriber line (DSL) connection, a telephone line connection, a coaxial cable system, a satellite system, a line-of-site wireless system, a cellular telephone system, an optical connection, etc.

The programmable circuitry platform 1300 of the illustrated example also includes one or more mass storage devices 1328 to store software and/or data. Examples of such mass storage devices 1328 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs.

The machine executable instructions 1332, which may be implemented by the machine readable instructions of FIGS. 3-5, may be stored in the mass storage device 1328, in the volatile memory 1314, in the non-volatile memory 1316, and/or on at least one non-transitory computer readable storage medium such as a CD or DVD which may be removable.

FIG. 14 is a block diagram of an example implementation of the programmable circuitry 1312 of FIG. 13. In this example, the programmable circuitry 1312 of FIG. 13 is implemented by a microprocessor 1400. For example, the microprocessor 1400 may be a general purpose microprocessor (e.g., general purpose microprocessor circuitry). The microprocessor 1400 executes some or all of the machine readable instructions of the flowcharts of FIGS. 3-5 to effectively instantiate the circuitry of FIG. 2 logic circuits to perform the operations corresponding to those machine readable instructions. In some such examples, the circuitry of FIG. 2 is instantiated by the hardware circuits of the microprocessor 1400 in combination with the instructions. For example, the microprocessor 1400 may implement multi-core hardware circuitry such as a CPU, a DSP, a GPU, an XPU, etc. Although it may include any number of example cores 1402 (e.g., 1 core), the microprocessor 1400 of this example is a multi-core semiconductor device including N cores. The cores 1402 of the microprocessor 1400 may operate independently or may cooperate to execute machine readable instructions. For example, machine code corresponding to a firmware program, an embedded software program, or a software program may be executed by one of the cores 1402 or may be executed by multiple ones of the cores 1402 at the same or different times. In some examples, the machine code corresponding to the firmware program, the embedded software program, or the software program is split into threads and executed in parallel by two or more of the cores 1402. The software program may correspond to a portion or all of the machine readable instructions and/or operations represented by the flowcharts of FIGS. 3-5.

The cores 1402 may communicate by a first example bus 1404. In some examples, the first bus 1404 may implement a communication bus to effectuate communication associated with one(s) of the cores 1402. For example, the first bus 1404 may implement at least one of an Inter-Integrated Circuit (I2C) bus, a Serial Peripheral Interface (SPI) bus, a PCI bus, or a PCIe bus. Additionally or alternatively, the first bus 1404 may implement any other type of computing or electrical bus. The cores 1402 may obtain data, instructions, and/or signals from one or more external devices by example interface circuitry 1406. The cores 1402 may output data, instructions, and/or signals to the one or more external devices by the interface circuitry 1406. Although the cores 1402 of this example include example local memory 1420 (e.g., Level 1 (L1) cache that may be split into an L1 data cache and an L1 instruction cache), the microprocessor 1400 also includes example shared memory 1410 that may be shared by the cores (e.g., Level 2 (L2_cache)) for high-speed access to data and/or instructions. Data and/or instructions may be transferred (e.g., shared) by writing to and/or reading from the shared memory 1410. The local memory 1420 of each of the cores 1402 and the shared memory 1410 may be part of a hierarchy of storage devices including multiple levels of cache memory and the main memory (e.g., the main memory 1314, 1316 of FIG. 13). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 1402 may be referred to as a CPU, DSP, GPU, etc., or any other type of hardware circuitry. Each core 1402 includes control unit circuitry 1414, arithmetic and logic (AL) circuitry (sometimes referred to as an ALU) 1416, a plurality of registers 1418, the L1 cache 1420, and a second example bus 1422. Other structures may be present. For example, each core 1402 may include vector unit circuitry, single instruction multiple data (SIMD) unit circuitry, load/store unit (LSU) circuitry, branch/jump unit circuitry, floating-point unit (FPU) circuitry, etc. The control unit circuitry 1414 includes semiconductor-based circuits structured to control (e.g., coordinate) data movement within the corresponding core 1402. The AL circuitry 1416 includes semiconductor-based circuits structured to perform one or more mathematic and/or logic operations on the data within the corresponding core 1402. The AL circuitry 1416 of some examples performs integer-based operations. In other examples, the AL circuitry 1416 also performs floating-point operations. In yet other examples, the AL circuitry 1416 may include first AL circuitry that performs integer-based operations and second AL circuitry that performs floating point operations. In some examples, the AL circuitry 1416 may be referred to as an Arithmetic Logic Unit (ALU).

The registers 1418 are semiconductor-based structures to store data and/or instructions such as results of one or more of the operations performed by the AL circuitry 1416 of the corresponding core 1402. For example, the registers 1418 may include vector register(s), SIMD register(s), general purpose register(s), flag register(s), segment register(s), machine specific register(s), instruction pointer register(s), control register(s), debug register(s), memory management register(s), machine check register(s), etc. The registers 1418 may be arranged in a bank as shown in FIG. 14. Alternatively, the registers 1418 may be organized in any other arrangement, format, or structure including distributed throughout the core 1402 to shorten access time. The second bus 1422 may be implemented by at least one of an I2C bus, a SPI bus, a PCI bus, or a PCIe bus.

Each core 1402 and/or, more generally, the microprocessor 1400 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 1400 is a semiconductor device fabricated to include many transistors interconnected to implement the structures described above in one or more integrated circuits (ICs) contained in one or more packages.

The microprocessor 1400 may include and/or cooperate with one or more accelerators (e.g., acceleration circuitry, hardware accelerators, etc.). In some examples, accelerators are implemented by logic circuitry to perform certain tasks more quickly and/or efficiently than can be done by a general-purpose processor. Examples of accelerators include ASICs and FPGAs such as those discussed herein. A GPU, DSP and/or other programmable device can also be an accelerator. Accelerators may be on-board the microprocessor 1400, in the same chip package as the microprocessor 1400 and/or in one or more separate packages from the microprocessor 1400.

FIG. 15 is a block diagram of another example implementation of the programmable circuitry of FIG. 13. In this example, the programmable circuitry 1312 is implemented by FPGA circuitry 1500. For example, the FPGA circuitry 1500 may be implemented by an FPGA. The FPGA circuitry 1500 can be used, for example, to perform operations that could otherwise be performed by the example microprocessor 1400 of FIG. 14 executing corresponding machine readable instructions. However, once configured, the FPGA circuitry 1500 instantiates the operations and/or functions corresponding to the machine readable instructions in hardware and, thus, can often execute the operations/functions faster than they could be performed by a general-purpose microprocessor executing the corresponding software.

More specifically, in contrast to the microprocessor 1400 of FIG. 14 described above (which is a general purpose device that may be programmed to execute some or all of the machine readable instructions represented by the flowcharts of FIGS. 3-5 but whose interconnections and logic circuitry are fixed once fabricated), the FPGA circuitry 1500 of the example of FIG. 15 includes interconnections and logic circuitry that may be configured, structured, programmed, and/or interconnected in different ways after fabrication to instantiate, for example, some or all of the operations/functions corresponding to the machine readable instructions represented by the flowcharts of FIGS. 3-5. In particular, the FPGA 1500 may be thought of as an array of logic gates, interconnections, and switches. The switches can be programmed to change how the logic gates are interconnected by the interconnections, effectively forming one or more dedicated logic circuits (unless and until the FPGA circuitry 1500 is reprogrammed). The configured logic circuits enable the logic gates to cooperate in different ways to perform different operations on data received by input circuitry. Those operations may correspond to some or all of the instructions (e.g., the software and/or firmware) represented by the flowcharts of FIGS. 3-5. As such, the FPGA circuitry 1500 may be configured and/or structured to effectively instantiate some or all of the operations/functions corresponding to the machine readable instructions of the flowcharts of FIGS. 3-5 as dedicated logic circuits to perform the operations/functions corresponding to those software instructions in a dedicated manner analogous to an ASIC. Therefore, the FPGA circuitry 1500 may perform the operations/functions corresponding to the some or all of the machine readable instructions of FIGS. 3-5 faster than the general-purpose microprocessor can execute the same.

In the example of FIG. 15, the FPGA circuitry 1500 is configured and/or structured in response to being programmed (and/or reprogrammed one or more times) based on a binary file. In some examples, the binary file may be compiled and/or generated based on instructions in a hardware description language (HDL) such as Lucid, Very High Speed Integrated Circuits (VHSIC) Hardware Description Language (VHDL), or Verilog. For example, a user (e.g., a human user, a machine user, etc.) may write code or a program corresponding to one or more operations/functions in an HDL; the code/program may be translated into a low-level language as needed; and the code/program (e.g., the code/program in the low-level language) may be converted (e.g., by a compiler, a software application, etc.) into the binary file. In some examples, the FPGA circuitry 1500 of FIG. 15 may access and/or load the binary file to cause the FPGA circuitry 1500 of FIG. 15 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 1500 of FIG. 15 to cause configuration and/or structuring of the FPGA circuitry 1500 of FIG. 15, or portion(s) thereof.

In some examples, the binary file is compiled, generated, transformed, and/or otherwise output from a uniform software platform utilized to program FPGAs. For example, the uniform software platform may translate first instructions (e.g., code or a program) that correspond to one or more operations/functions in a high-level language (e.g., C, C++, Python, etc.) into second instructions that correspond to the one or more operations/functions in an HDL. In some such examples, the binary file is compiled, generated, and/or otherwise output from the uniform software platform based on the second instructions. In some examples, the FPGA circuitry 1500 of FIG. 15 may access and/or load the binary file to cause the FPGA circuitry 1500 of FIG. 15 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 1500 of FIG. 15 to cause configuration and/or structuring of the FPGA circuitry 1500 of FIG. 15, or portion(s) thereof.

The FPGA circuitry 1500 of FIG. 15, includes example input/output (I/O) circuitry 1502 to obtain and/or output data to/from example configuration circuitry 1504 and/or external hardware 1506. For example, the configuration circuitry 1504 may be implemented by interface circuitry that may obtain a binary file, which may be implemented by a bit stream, data, and/or machine-readable instructions, to configure the FPGA circuitry 1500, or portion(s) thereof. In some such examples, the configuration circuitry 1504 may obtain the binary file from a user, a machine (e.g., hardware circuitry (e.g., programmable or dedicated circuitry) that may implement an Artificial Intelligence/Machine Learning (AI/ML) model to generate the binary file), etc., and/or any combination(s) thereof). In some examples, the external hardware 1506 may be implemented by external hardware circuitry. For example, the external hardware 1506 may be implemented by the microprocessor 1400 of FIG. 14.

The FPGA circuitry 1500 also includes an array of example logic gate circuitry 1508, a plurality of example configurable interconnections 1510, and example storage circuitry 1512. The logic gate circuitry 1508 and the configurable interconnections 1510 are configurable to instantiate one or more operations/functions that may correspond to at least some of the machine readable instructions of FIGS. 3-5 and/or other desired operations. The logic gate circuitry 1508 shown in FIG. 15 is fabricated in blocks or groups. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 1508 to enable configuration of the electrical structures and/or the logic gates to form circuits to perform desired operations/functions. The logic gate circuitry 1508 may include other electrical structures such as look-up tables (LUTs), registers (e.g., flip-flops or latches), multiplexers, etc.

The configurable interconnections 1510 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 1508 to program desired logic circuits.

The storage circuitry 1512 of the illustrated example is structured to store result(s) of the one or more of the operations performed by corresponding logic gates. The storage circuitry 1512 may be implemented by registers or the like. In the illustrated example, the storage circuitry 1512 is distributed amongst the logic gate circuitry 1508 to facilitate access and increase execution speed.

The example FPGA circuitry 1500 of FIG. 15 also includes example dedicated operations circuitry 1514. In this example, the dedicated operations circuitry 1514 includes special purpose circuitry 1516 that may be invoked to implement commonly used functions to avoid the need to program those functions in the field. Examples of such special purpose circuitry 1516 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 1500 may also include example general purpose programmable circuitry 1518 such as an example CPU 1520 and/or an example DSP 1522. Other general purpose programmable circuitry 1518 may additionally or alternatively be present such as a GPU, an XPU, etc., that can be programmed to perform other operations.

Although FIGS. 14 and 15 illustrate two example implementations of the programmable circuitry 1312 of FIG. 13, many other approaches are contemplated. For example, FPGA circuitry may include an on-board CPU, such as one or more of the example CPU 1520 of FIG. 15. Therefore, the programmable circuitry 1312 of FIG. 13 may additionally be implemented by combining at least the example microprocessor 1400 of FIG. 14 and the example FPGA circuitry 1500 of FIG. 15. In some such hybrid examples, one or more cores 1502 of FIG. 15 may execute a first portion of the machine readable instructions represented by the flowchart(s) of FIGS. 3-5 to perform first operation(s)/function(s), the FPGA circuitry 1500 of FIG. 15 may be configured and/or structured to perform second operation(s)/function(s) corresponding to a second portion of the machine readable instructions represented by the flowcharts of FIGS. 3-5, and/or an ASIC may be configured and/or structured to perform third operation(s)/function(s) corresponding to a third portion of the machine readable instructions represented by the flowcharts of FIGS. 3-5.

It should be understood that some or all of the circuitry of FIG. 2 may, thus, be instantiated at the same or different times. For example, same and/or different portion(s) of the microprocessor 1400 of FIG. 14 may be programmed to execute portion(s) of machine-readable instructions at the same and/or different times. In some examples, same and/or different portion(s) of the FPGA circuitry 1500 of FIG. 15 may be configured and/or structured to perform operations/functions corresponding to portion(s) of machine-readable instructions at the same and/or different times.

In some examples, some or all of the circuitry of FIG. 2 may be instantiated, for example, in one or more threads executing concurrently and/or in series. For example, the microprocessor 1400 of FIG. 14 may execute machine readable instructions in one or more threads executing concurrently and/or in series. In some examples, the FPGA circuitry 1500 of FIG. 15 may be configured and/or structured to carry out operations/functions concurrently and/or in series. Moreover, in some examples, some or all of the circuitry of FIG. 2 may be implemented within one or more virtual machines and/or containers executing on the microprocessor 1400 of FIG. 14.

In some examples, the programmable circuitry 1312 of FIG. 13 may be in one or more packages. For example, the microprocessor 1400 of FIG. 14 and/or the FPGA circuitry 1500 of FIG. 15 may be in one or more packages. In some examples, an XPU may be implemented by the programmable circuitry 1312 of FIG. 13 which may be in one or more packages. For example, the XPU may include a CPU (e.g., the microprocessor 1400 of FIG. 14, the CPU 1520 of FIG. 15, etc.) in one package, a DSP (e.g., the DSP 1522 of FIG. 15) in another package, a GPU in yet another package, and an FPGA (e.g., the FPGA circuitry 1500 of FIG. 15) in still yet another package.

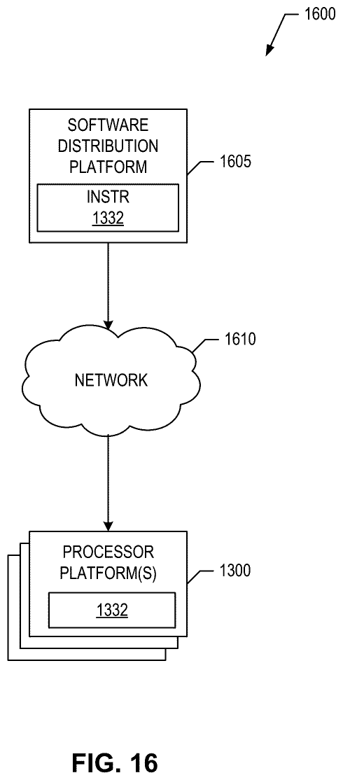

A block diagram illustrating an example software distribution platform 1605 to distribute software such as the example machine readable instructions 1332 of FIG. 13 to other hardware devices (e.g., hardware devices owned and/or operated by third parties from the owner and/or operator of the software distribution platform) is illustrated in FIG. 16. The example software distribution platform 1605 may be implemented by any computer server, data facility, cloud service, etc., capable of storing and transmitting software to other computing devices. The third parties may be customers of the entity owning and/or operating the software distribution platform 1605. For example, the entity that owns and/or operates the software distribution platform 1605 may be a developer, a seller, and/or a licensor of software such as the example machine readable instructions 1332 of FIG. 13. The third parties may be consumers, users, retailers, OEMs, etc., who purchase and/or license the software for use and/or re-sale and/or sub-licensing. In the illustrated example, the software distribution platform 1305 includes one or more servers and one or more storage devices. The storage devices store the machine readable instructions 1332, which may correspond to the example machine readable instructions of FIGS. 3-5, as described above. The one or more servers of the example software distribution platform 1305 are in communication with an example network 1310, which may correspond to any one or more of the Internet and/or any of the example networks described above. In some examples, the one or more servers are responsive to requests to transmit the software to a requesting party as part of a commercial transaction. Payment for the delivery, sale, and/or license of the software may be handled by the one or more servers of the software distribution platform and/or by a third party payment entity. The servers enable purchasers and/or licensors to download the machine readable instructions 1332 from the software distribution platform 1605. For example, the software, which may correspond to the example machine readable instructions of FIGS. 3-5, may be downloaded to the example programmable circuitry platform 1300, which is to execute the machine readable instructions 1332 to implement the model tuner circuitry 205 of FIG. 2. In some examples, one or more servers of the software distribution platform 1605 periodically offer, transmit, and/or force updates to the software (e.g., the example machine readable instructions 1332 of FIG. 13) to ensure improvements, patches, updates, etc., are distributed and applied to the software at the end user devices. Although referred to as software above, the distributed “software” could alternatively be firmware.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, etc., the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, etc., the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “programmable circuitry” is defined to include (i) one or more special purpose electrical circuits (e.g., an application specific circuit (ASIC)) structured to perform specific operation(s) and including one or more semiconductor-based logic devices (e.g., electrical hardware implemented by one or more transistors), and/or (ii) one or more general purpose semiconductor-based electrical circuits programmable with instructions to perform specific functions(s) and/or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations and/or functions, Field Programmable Gate Arrays (FPGAs) that may be programmed with second instructions to cause configuration and/or structuring of the FPGAs to instantiate one or more operations and/or functions corresponding to the first instructions, Graphics Processor Units (GPUs) that may execute first instructions to perform one or more operations and/or functions, Digital Signal Processors (DSPs) that may execute first instructions to perform one or more operations and/or functions, XPUs, Network Processing Units (NPUs) one or more microcontrollers that may execute first instructions to perform one or more operations and/or functions and/or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and/or any combination(s) thereof), and orchestration technology (e.g., application programming interface(s) (API(s)) that may assign computing task(s) to whichever one(s) of the multiple types of programmable circuitry is/are suited and available to perform the computing task(s).

As used herein integrated circuit/circuitry is defined as one or more semiconductor packages containing one or more circuit elements such as transistors, capacitors, inductors, resistors, current paths, diodes, etc. For example, an integrated circuit may be implemented as one or more of an ASIC, an FPGA, a chip, a microchip, programmable circuitry, a semiconductor substrate coupling multiple circuit elements, a system on chip (SoC), etc.

From the foregoing, it will be appreciated that example systems, methods, apparatus, and articles of manufacture disclosed herein permit unstructured sparsity in low-precision large pre-trained foundation models. Fine-tuning of LLMs is improved while maintaining a low count of trainable parameters and resource requirements. As such, machine learning-based inference can be accelerated by using fewer parameters as compared to known sparse fine-tuning. For example, model sparsity can be exploited with little (e.g., minimal) compression loss, resulting in significant acceleration, demonstrating that the resulting sparse model can alleviate existing memory bandwidth challenges. Thus, examples disclosed herein result in improvements to the operation of a machine.

Example methods, apparatus, systems, and articles of manufacture for enabling unstructured sparsity in low-precision large pre-trained foundation models are disclosed herein. Further examples and combinations thereof include the following:

Example 1 includes an apparatus, comprising interface circuitry, machine-readable instructions, and at least one processor circuit to be programmed by the machine-readable instructions to sparsify a base model of a foundation model to generate a sparse base model, apply a neural low-rank adapter search to the sparse base model, and output a fine-tuned base model based on application of the neural low-rank adapter search to the sparse base model.

Example 2 includes the apparatus of example 1, wherein one or more of the at least one processor circuit is to sparsify the base model by identifying a sparsity pattern associated with sparsified weights of the base model.

Example 3 includes the apparatus of one or more of examples 1-2, wherein one or more of the at least one processor circuit is to identify the sparsified weights based on a scoring function applied to pre-trained weights of the base model.

Example 4 includes the apparatus of one or more of examples 1-3, wherein when the fine-tuned base model is a sparsified-and-quantized base model, the one or more of the at least one processor circuit is to identify the sparsified-and-quantized base model by quantizing the sparsified weights to a lower precision.

Example 5 includes the apparatus of example 1, wherein one or more of the at least one processor circuit is to generate a binary mask based on the sparse base model, the binary mask derived from an initial sparsification of a weight matrix of the base model.

Example 6 includes the apparatus of example 1, wherein one or more of the at least one processor circuit is to apply the neural low-rank adapter search to train elastic adapters with variable configurations to improve accuracy of the fine-tuned base model.

Example 7 includes the apparatus of one or more of examples 1-6, wherein the variable configurations represent variable ranking values as compared to fixed ranking values.

Example 8 includes the apparatus of one or more of examples 1-7, wherein the neural low-rank adapter search is to apply the variable ranking values to the elastic adapters to identify a single elastic adapter configuration from a space of elastic adapter configurations.

Example 9 includes the apparatus of one or more of examples 1-6, wherein one or more of the at least one processor circuit is to merge the elastic adapters and model weights of the base model after fine-tuning while maintaining sparsity of the model weights.

Example 10 includes at least one non-transitory machine-readable medium comprising machine-readable instructions to cause at least one processor circuit to at least sparsify a base model of a foundation model to generate a sparse base model, apply a neural low-rank adapter search to the sparse base model, and output a fine-tuned base model based on application of the neural low-rank adapter search to the sparse base model.

Example 11 includes the at least one non-transitory machine-readable medium of example 10, wherein the machine-readable instructions are to cause one or more of the at least one processor circuit to sparsify the base model by identifying a sparsity pattern associated with sparsified weights of the base model.

Example 12 includes the at least one non-transitory machine-readable medium of one or more of examples 10-11, wherein the machine-readable instructions are to cause one or more of the at least one processor circuit to identify the sparsified weights based on a scoring function applied to pre-trained weights of the base model.

Example 13 includes the at least one non-transitory machine-readable medium of one or more of examples 10-12, wherein, the fine-tuned base model is a sparsified-and-quantized base model, and the machine-readable instructions are to cause one or more of the at least one processor circuit to identify the sparsified-and-quantized base model by quantizing the sparsified weights to a lower precision.

Example 14 includes the at least one non-transitory machine-readable medium of example 10, wherein the machine-readable instructions are to cause one or more of the at least one processor circuit to generate a binary mask based on the sparse base model, the binary mask derived from an initial sparsification of a weight matrix of the base model.

Example 15 includes the at least one non-transitory machine-readable medium of example 10, wherein the machine-readable instructions are to cause one or more of the at least one processor circuit to apply the neural low-rank adapter search to train elastic adapters with variable configurations to improve accuracy of the fine-tuned base model.

Example 16 includes the at least one non-transitory machine-readable medium of one or more of examples 10-15, wherein the variable configurations represent variable ranking values as compared to fixed ranking values.

Example 17 includes the at least one non-transitory machine-readable medium of one or more of examples 10-16, wherein the neural low-rank adapter search is to apply the variable ranking values to the elastic adapters to identify a single elastic adapter configuration from a space of elastic adapter configurations.

Example 18 includes the at least one non-transitory machine-readable medium of one or more of examples 10-16, wherein the machine-readable instructions are to cause one or more of the at least one processor circuit to merge the elastic adapters and model weights of the base model after fine-tuning while maintaining sparsity of the model weights.

Example 19 includes an apparatus, comprising means for sparsifying a base model of a foundation model to generate a sparse base model, means for applying a neural low-rank adapter search to the sparse base model, and means for outputting a fine-tuned base model based on application of the neural low-rank adapter search to the sparse base model.

Example 20 includes the apparatus of example 19, wherein the means for sparsifying include identifying a sparsity pattern associated with sparsified weights of the base model.

Example 21 includes the apparatus of one or more of examples 19-20, wherein the means for sparsifying include identifying the sparsified weights based on a scoring function applied to pre-trained weights of the base model.

Example 22 includes the apparatus of one or more of examples 19-21, wherein the fine-tuned base model is a sparsified-and-quantized base model, and including means for performing quantization to identify the sparsified-and-quantized base model by quantizing the sparsified weights to a lower precision.

Example 23 includes the apparatus of example 19, including means for weight merging to generate a binary mask based on the sparse base model, the binary mask derived from an initial sparsification of a weight matrix of the base model.

Example 24 includes the apparatus of example 19, wherein the means for applying a neural low-rank adapter search include training elastic adapters with variable configurations to improve accuracy of the fine-tuned base model.

Example 25 includes the apparatus of one or more of examples 19-24, wherein the variable configurations represent variable ranking values as compared to fixed ranking values.

Example 26 includes the apparatus of one or more of examples 19-25, wherein the means for applying the neural low-rank adapter search include applying the variable ranking values to the elastic adapters to identify a single elastic adapter configuration from a space of elastic adapter configurations.

Example 27 includes the apparatus of one or more of examples 19-24, wherein the means for applying the neural low-rank adapter search include merging the elastic adapters and model weights of the base model after fine-tuning while maintaining sparsity of the model weights.

Example 28 includes a method, comprising sparsifying a base model of a foundation model to generate a sparse base model, applying a neural low-rank adapter search to the sparse base model, and outputting a fine-tuned base model based on application of the neural low-rank adapter search to the sparse base model.

Example 29 includes the method of example 28, further including sparsifying the base model by identifying a sparsity pattern associated with sparsified weights of the base model.

Example 30 includes the method of one or more of examples 28-29, further including identifying the sparsified weights based on a scoring function applied to pre-trained weights of the base model.

Example 31 includes the method of one or more of examples 28-30, wherein when the fine-tuned base model is a sparsified-and-quantized base model, further including identifying the sparsified-and-quantized base model by quantizing the sparsified weights to a lower precision.

Example 32 includes the method of example 28, further including generating a binary mask based on the sparse base model, the binary mask derived from an initial sparsification of a weight matrix of the base model.

Example 33 includes the method of example 28, further including applying the neural low-rank adapter search to train elastic adapters with variable configurations to improve accuracy of the fine-tuned base model.

Example 34 includes the method of one or more of examples 28-33, wherein the variable configurations represent variable ranking values as compared to fixed ranking values.

Example 35 includes the method of one or more of examples 28-34, wherein the neural low-rank adapter search is to apply the variable ranking values to the elastic adapters to identify a single elastic adapter configuration from a space of elastic adapter configurations.

Example 36 includes the method of one or more of examples 28-33, further including merging the elastic adapters and model weights of the base model after fine-tuning while maintaining sparsity of the model weights.

The following claims are hereby incorporated into this Detailed Description by this reference. Although certain example systems, methods, apparatus, and articles of manufacture have been disclosed herein, the scope of coverage of this patent is not limited thereto. On the contrary, this patent covers all systems, methods, apparatus, and articles of manufacture fairly falling within the scope of the claims of this patent.

What is claimed is:

1. An apparatus, comprising:
interface circuitry;
machine-readable instructions; and
at least one processor circuit to be programmed by the machine-readable instructions to:
sparsify a base model of a foundation model to generate a sparse base model;
apply a neural low-rank adapter search to the sparse base model; and
output a fine-tuned base model based on application of the neural low-rank adapter search to the sparse base model.

2. The apparatus of claim 1, wherein one or more of the at least one processor circuit is to sparsify the base model by identifying a sparsity pattern associated with sparsified weights of the base model.

3. The apparatus of claim 2, wherein one or more of the at least one processor circuit is to identify the sparsified weights based on a scoring function applied to pre-trained weights of the base model.

4. The apparatus of claim 3, wherein when the fine-tuned base model is a sparsified-and-quantized base model, the one or more of the at least one processor circuit is to identify the sparsified-and-quantized base model by quantizing the sparsified weights to a lower precision.

5. The apparatus of claim 1, wherein one or more of the at least one processor circuit is to generate a binary mask based on the sparse base model, the binary mask derived from an initial sparsification of a weight matrix of the base model.

6. The apparatus of claim 1, wherein one or more of the at least one processor circuit is to apply the neural low-rank adapter search to train elastic adapters with variable configurations to improve accuracy of the fine-tuned base model.

7. The apparatus of claim 6, wherein the variable configurations represent variable ranking values as compared to fixed ranking values.

8. The apparatus of claim 7, wherein the neural low-rank adapter search is to apply the variable ranking values to the elastic adapters to identify a single elastic adapter configuration from a space of elastic adapter configurations.

9. The apparatus of claim 6, wherein one or more of the at least one processor circuit is to merge the elastic adapters and model weights of the base model after fine-tuning while maintaining sparsity of the model weights.

10. At least one non-transitory machine-readable medium comprising machine-readable instructions to cause at least one processor circuit to at least:
sparsify a base model of a foundation model to generate a sparse base model;
apply a neural low-rank adapter search to the sparse base model; and
output a fine-tuned base model based on application of the neural low-rank adapter search to the sparse base model.

11. The at least one non-transitory machine-readable medium of claim 10, wherein the machine-readable instructions are to cause one or more of the at least one processor circuit to sparsify the base model by identifying a sparsity pattern associated with sparsified weights of the base model.

12. The at least one non-transitory machine-readable medium of claim 11, wherein the machine-readable instructions are to cause one or more of the at least one processor circuit to identify the sparsified weights based on a scoring function applied to pre-trained weights of the base model.

13. The at least one non-transitory machine-readable medium of claim 12, wherein, the fine-tuned base model is a sparsified-and-quantized base model, and the machine-readable instructions are to cause one or more of the at least one processor circuit to identify the sparsified-and-quantized base model by quantizing the sparsified weights to a lower precision.

14. The at least one non-transitory machine-readable medium of claim 10, wherein the machine-readable instructions are to cause one or more of the at least one processor circuit to generate a binary mask based on the sparse base model, the binary mask derived from an initial sparsification of a weight matrix of the base model.

15. The at least one non-transitory machine-readable medium of claim 10, wherein the machine-readable instructions are to cause one or more of the at least one processor circuit to apply the neural low-rank adapter search to train elastic adapters with variable configurations to improve accuracy of the fine-tuned base model.

16. The at least one non-transitory machine-readable medium of claim 15, wherein the variable configurations represent variable ranking values as compared to fixed ranking values.

17. The at least one non-transitory machine-readable medium of claim 16, wherein the neural low-rank adapter search is to apply the variable ranking values to the elastic adapters to identify a single elastic adapter configuration from a space of elastic adapter configurations.

18. The at least one non-transitory machine-readable medium of claim 16, wherein the machine-readable instructions are to cause one or more of the at least one processor circuit to merge the elastic adapters and model weights of the base model after fine-tuning while maintaining sparsity of the model weights.

19. An apparatus, comprising:
means for sparsifying a base model of a foundation model to generate a sparse base model;
means for applying a neural low-rank adapter search to the sparse base model; and
means for outputting a fine-tuned base model based on application of the neural low-rank adapter search to the sparse base model.

20. The apparatus of claim 19, wherein the means for sparsifying include identifying a sparsity pattern associated with sparsified weights of the base model.
